(19) United States
(12) Patent Application Publication
(10) Pub. No.: US 2024/0419805 A1
(43) Pub. Date: Dec. 19, 2024

(54) ENHANCED SECURITY FEATURES FOR MESSAGE AND CALL SYSTEMS USING AN ACTIVITY HEATMAP WITH COOLDOWN PERIODS

(71) Applicant: MICROSOFT TECHNOLOGY LICENSING, LLC, Redmond, WA (US)

(72) Inventor: Kirill Linnik, Talinn (EE)

(21) Appl. No.: 18/336,853

(22) Filed: Jun. 16, 2023

(51) Int. Cl. G06F 21/57

(52) U.S. Cl. CPC G06F 21/577; G06F 2221/034

(57) ABSTRACT

The techniques disclosed herein provide a method of fraud mitigation in messaging and call systems using a heatmap with a cooldown approach. The heatmap is created using scores assigned to the mobile numbers. The score for each number is calculated based on the historical record of calls or messages to numbers within a predetermined range. In general, an increased number of messages or calls for numbers within a range increases a score for numbers within that range. The system can reduce the scores or reset the scores over a period of time. This reduction or reset of the scores, which is referred to herein as “forgetting” deliverables, provides a cooldown approach. With this cooldown approach, new and fresh patterns can be identified faster using accurate and current data. When a score for a number reaches or exceeds an activity threshold, one or more security measures may be implemented.

### BACKGROUND

Fraud and spam are rising through communication channels like SMS, MMS, and RCS. Intruders are getting very diverse and creative. Today, there are many possible attack vectors that include exploiting vulnerabilities of devices, financial fraud, identity theft, spoofing, etc. In other practices include distribution of illegal or abusive content, revenue sharing attacks, etc.

These deceptive practices are typically carried out through commercial systems, which is damaging to businesses managing those systems in terms of both public reputation and financial results. For example, when an attacker uses a system to send fraudulent or deceptive messages, the attacker can appear to be sponsored by a company managing the messaging system. In addition, those fraudulent or deceptive messages cause those companies to incur large expenses. This is due to the fact that the companies providing a platform usually pays service providers and carriers for the messages sent to recipients. For example, when SMS messages are used for a company second factor authentication (2FA), a Teams invitation, or Skype a number validation, that company has to pay a fee for each message to downstream partners, such as a telecom company. Given the volumes of messages generated by those systems, the financial and computing resource losses are significant.

One of the biggest challenges involves Revenue Share Fraud. Revenue Share Fraud refers to a deceptive practice where individuals or organizations manipulate revenue-sharing systems to generate illicit profits. It typically occurs in affiliate marketing or advertising models where revenue is shared between the parties involved. These deceptive practices involve many different attack vectors. For example, message systems can be used in the creation of fake accounts. Fraudsters create multiple fake accounts or use a network of bot-controlled accounts to artificially inflate the number of users or engagements. Fraudsters also create false clicks or impressions. They generate fraudulent clicks or impressions on advertisements or affiliate links, making it seem like legitimate traffic is being driven to the advertiser's website or affiliate offers. Fraudsters may also engage in fraudulent activities to create artificial conversions, such as fake purchases or sign-ups, to earn a share of the revenue. Fraudsters may utilize various techniques like traffic hijacking, ad stacking, or domain spoofing to redirect legitimate traffic to their own websites or landing pages, thereby increasing their revenue share. Fraudsters might also collaborate with other individuals or networks to exchange traffic or engage in click fraud, amplifying the impact of their fraudulent activities. These fraudulent practices deceive advertisers, affiliate networks, or revenue-sharing platforms by artificially inflating engagement metrics, leading to higher payouts or commissions for the fraudsters. It can result in significant financial losses for legitimate businesses involved in revenue-sharing models.

Fraudsters usually carry out an attack by creating and registering a virtual operator or virtual carrier. They can then create accounts with any platform supporting 2FA, such as Twitter, Microsoft, or Google. For each account that is created, they attach numbers belonging to people as ones used for 2FA. They can then login and trigger 2FA messages. They then intercept the incoming messages easily since they own the virtual operator or the virtual carrier. They can then obtain the code and use it for authorization. As a result, from the service provider perspective, the traffic looks legit as someone was asking for a code and used it. The fraudster, as the operator or carrier owner, is getting paid for incoming messages by the companies such as Twitter, Microsoft, or Google. The more incoming traffic the carrier has, the more money they earn. That is the reason carrier packages for end users are outbound-data based, as in this case carrier pays for it and they want to transfer this cost to the end user.

The idea of shutting down these messaging channels to address this kind of fraud is difficult. Unfortunately, it would be unreasonable to close these channels as closing such channels would raise security concerns. Thus, other security measures are needed to address these problems that incur costs, create security concerns, and cause lots of unnecessary use of computing resources and network resources.

### SUMMARY

The techniques disclosed herein provide enhanced security features for fraud mitigation in message and call systems using activity heatmaps with cooldown periods. A system can utilize an activity heatmap to identify specific call and message activity patterns to detect SPAM, fraud, and malicious bot activity. The system can then invoke specific security measure operations after detecting such bot activity. A heatmap represents how a score for a mobile number is generated. The score is based on a number of messages received at a specific phone number and phone numbers surrounding that specific number. The score for each number is calculated based on the historical record of calls or messages to numbers within a predetermined range. In general, an increased number of messages or calls for numbers within a predetermined range, increases a score for numbers within that range. Then, based on a cooldown period, the system can reduce the scores or reset the scores over the cooldown period. This reduction of scores over the cooldown period provides an approach where older messages in a message or call history have less of an influence on generated scores over time. Eventually, when the cooldown period has lapsed, the system can reset the scoring parameters and not allow the system to be influenced by older messages, which is referred to herein as “forgetting” deliverables. With this cooldown approach, new and fresh patterns can be identified faster using accurate and current data.

When a score for a number reaches or exceeds an activity threshold, one or more security measures may be implemented. In one example of a security measure, the system may require an account associated with the number to use other forms of messaging. For example, when a score for a phone number reaches a threshold, the system may require an associated account to use emails for second factor authentication. This allows users to still use second factor authentication features but bypass any message or call system that incurs high costs for each message. This also allows a system to bypass a message or call system where messages can be intercepted by a virtual carrier. In addition, the cooldown feature allows more flexibility for some accounts to send higher volumes of calls or messages to a number while mitigating the occurrences of false alarms that trigger security measures. The security measures can also include a number of other operations for providing notifications of specific patterns of activity, or any other suitable security measure that can control the communication of messages for flagged phone numbers.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for providing enhanced security features for fraud mitigation in messaging and call systems using activity heatmaps with cooldown periods.

FIG. 2A shows first stage of a scoring process utilizing a distance heatmap.

FIG. 2B shows a second stage of a scoring process utilizing a distance heatmap.

FIG. 2C shows a third stage of a scoring process utilizing a distance heatmap.

FIG. 2D shows a fourth stage of a scoring process utilizing a distance heatmap.

FIG. 3 shows an example representation of functions that can be used with a distance heatmap.

FIG. 4A shows a first stage of a scoring process utilizing a ranged heatmap.

FIG. 4B shows a second stage of a scoring process utilizing a ranged heatmap.

FIG. 5 shows an example representation of functions that can be used with a ranged heatmap.

FIG. 6A shows a first stage of a scoring process utilizing a distance heatmap with a cooldown period.

FIG. 6B shows a second stage of a scoring process utilizing a distance heatmap with a cooldown period.

FIG. 7A shows a first stage of a scoring process utilizing a distance heatmap with a cooldown period.

FIG. 7B shows a second stage of a scoring process utilizing a distance heatmap with a cooldown period.

FIG. 7C shows a third stage of a scoring process utilizing a distance heatmap with a cooldown period.

FIG. 8A shows a first stage of a scoring process utilizing a ranged heatmap with a cooldown period.

FIG. 8B shows a second stage of a scoring process utilizing a ranged heatmap with a cooldown period.

FIG. 8C shows a third stage of a scoring process utilizing a ranged heatmap with a cooldown period.

FIG. 9 is a flow diagram showing aspects of a routine for utilizing the network effect of end-user viral adoption of services and applications by clustering users based on characteristics of requests to configure new tenants.

FIG. 10 is a computer architecture diagram illustrating an illustrative computer hardware and software architecture for a computing system capable of implementing aspects of the techniques and technologies presented herein.

### DETAILED DESCRIPTION

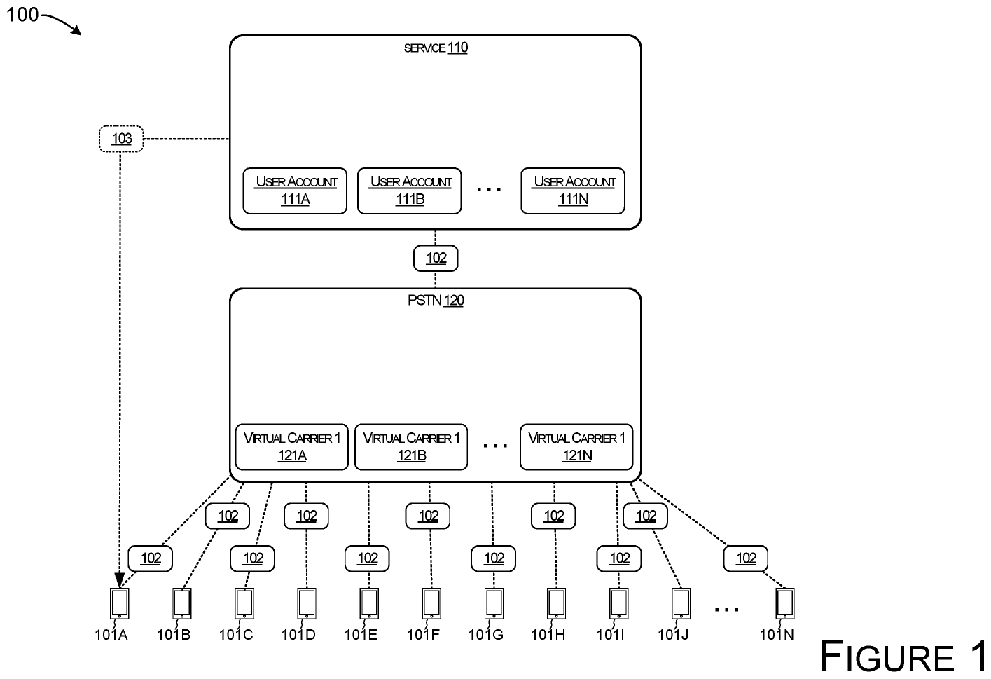

FIG. 1 illustrates a system 100 that can be utilized with the disclosed techniques.

The system can include a service 110, a public switched telephone network (PSTN) 120, and a number of mobile devices 101. The service 110 can provide one or more services, such as network services, storage services, or other types of services that provide any type of computing resource. For example, the service 110 can include features for storing and sharing social media content for its user accounts 111. The PSTN can receive messages 102 from the service 110 and communicate those messages 102 to mobile devices 101. In one example scenario, an end user associated with a device 101A may have an account 101A on the service. To access their account 111A on the service 110, the user may cause the service to send a F2A message from the service 110 to their phone 101A via the PSTN 120. In another scenario, a virtual carrier 121A may control a number phone numbers for different phones 101A-101N, and also control one or more accounts 111A-111N on the service 110. In this scenario, an entity may instruct the service 110 to generate a number of messages to be sent to a number of the phones 101A-101N. In doing so, the entity controlling the virtual carrier 121A can also intercept the messages sent from the service 110 to each phone. This information may be used by a bot to simulate legitimate user activity by completing an F2A process.

In one illustrative example, a party can create a virtual career and they also create accounts with Twitter. They then enable the two-factor authentication. They also own the number, then they trigger the two-factor authentication. So they create and register virtual carriers, they create accounts with any platform that uses two-factor authentication, such as Twitter, Microsoft or Google. For all these accounts that are created, they attach numbers they own as one should be used for the two-factor authentication. Then they log in and trigger the two-factor authentication. Because they are also the mobile carrier, e.g., a virtual carrier, they can intercept this traffic. The party can actually get the content of this two-factor authentication message. This way, they get the two-factor authentication code and perform a successful login. So, from the platform perspective, the platform can say it is secure because this activity looks like a successful login. If the two-factor authentication message was sent and no one logged in, that is usually triggered as suspicious activity. So the new schemes today using an actual login can simulate real user activity even if it is performed by bots in high volumes. They start to also explore some expensive destinations where messages cost a platform high messaging fees. Currently, for example, some SMS messages are 0.3 cents at a wholesale price. these new tactics more techniques are needed to detect parties that are is behaving correctly and parties are not.

In some cases, most users have numbers that are randomly assigned. But in the case of virtual carriers, these numbers will become close to each other. In some cases, they are generally a range of sequential numbers. For example, a virtual carrier may be assigned phone numbers ending in a range of 1001 to 1999. Given this pattern, the techniques disclosed herein can analyze behavioral patterns for a range of numbers.

The disclosed techniques can identify specific types of patterns that are used to circumvent other forms of fraud detection methods. For example, fraudsters do not take a straight approach of texting a single number several thousand times per minute, because that is immediate triggers anti-spam systems. So fraudsters use a range of numbers, and they the range as cautiously as possible. They can select one number, send an SMS, select a second number, send another SMS, select other subsequent numbers and send SMS messages to each of the numbers. They then put that in a loop and send message to each of the number repeatedly. This calling or message pattern can help reduce visibility to some anti-spam systems.

The disclosed techniques can involve a process where a select set of numbers are monitored. Each time a message is sent to a phone number, the service can determine a score for that phone number. The service 110 determines individual scores for individual phone numbers in response to the service detecting the communication of the individual messages. The service can use a message history log to generate the score. Scores do not need to be recorded for future calculations. An individual score for an individual phone number is based on the activity heatmap defining a number of messages directed to the individual phone number and a number of messages directed to other phone numbers associated with the individual number. As described in more detail below, different types of heatmaps can be used, and different score cooldown techniques can be used as well.

The service analyzes each generated score in view of a security threshold. In response to determining that the individual score for the individual phone number meets one or more criteria with respect to the security threshold, the service can invoke a security measure for the individual phone number. The security measure includes at least one of generating a notification, requiring accounts associated with the individual phone number to utilize other alternative message systems, or requiring accounts associated with the individual phone number to upgrade permissions. For example, as shown in FIG. 1, once a security measure is invoked, the service may restrict the communication of the first message delivery system, e.g., SMS messages, and use an alternative message delivery system, such as email. A shown in this example, if a message log for the first device 101A causes the system to generate a score above a security threshold, the system can restrict the SMS messages 102, and cause the first user account 111A, to only use emails 103 for certain functions, such as F2A authentications.

In some embodiments, scores for each number are determined by the use of a distance heatmap. In the distance heatmap method, a score for an individual number influenced by a difference, e.g., a distance, between the number receiving a message and numbers that have received other messages. The score can be based on a call history record. When a number receives a first message, the system assigns a score for that number that is based on a number of messages received for that number and a number of messages received for other numbers that are around that number.

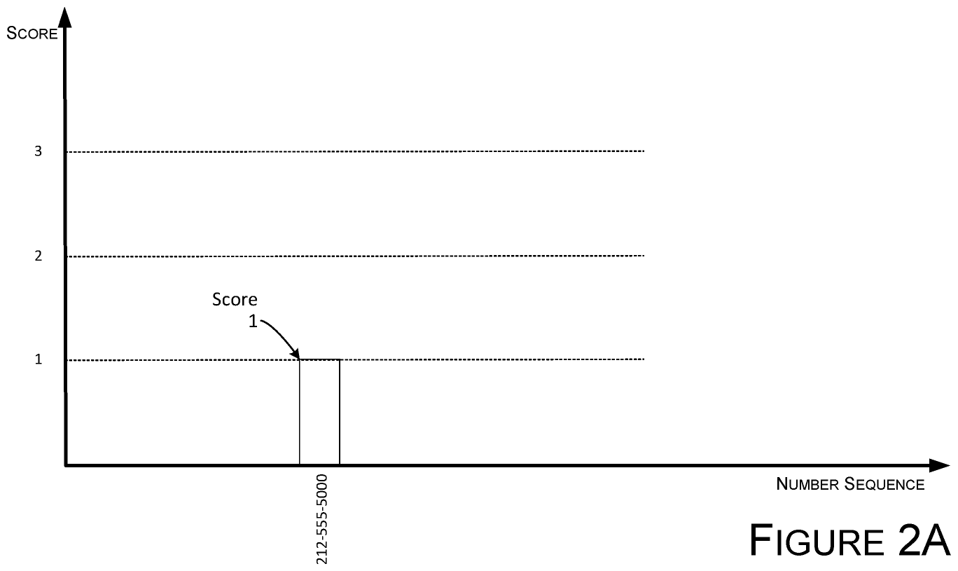

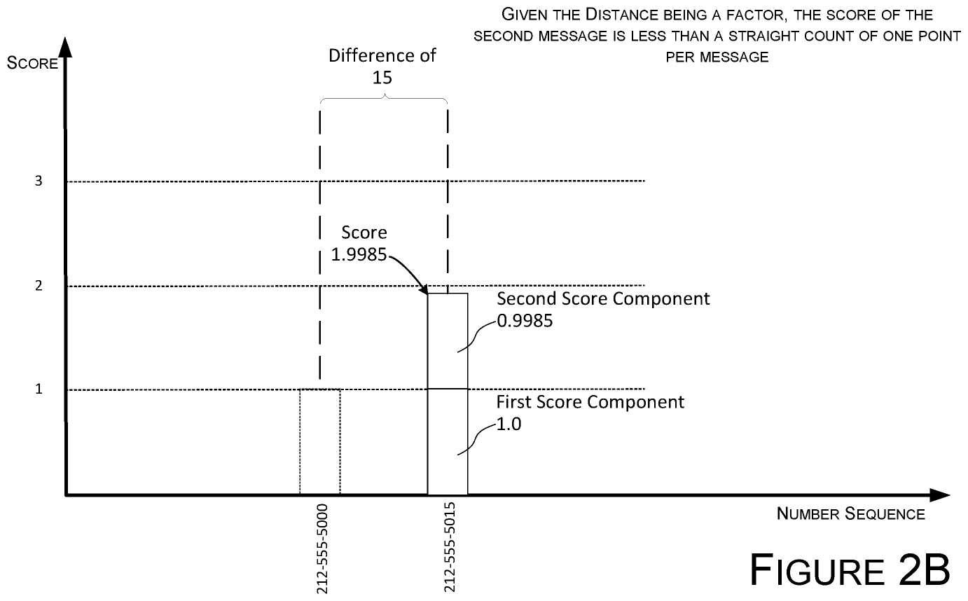

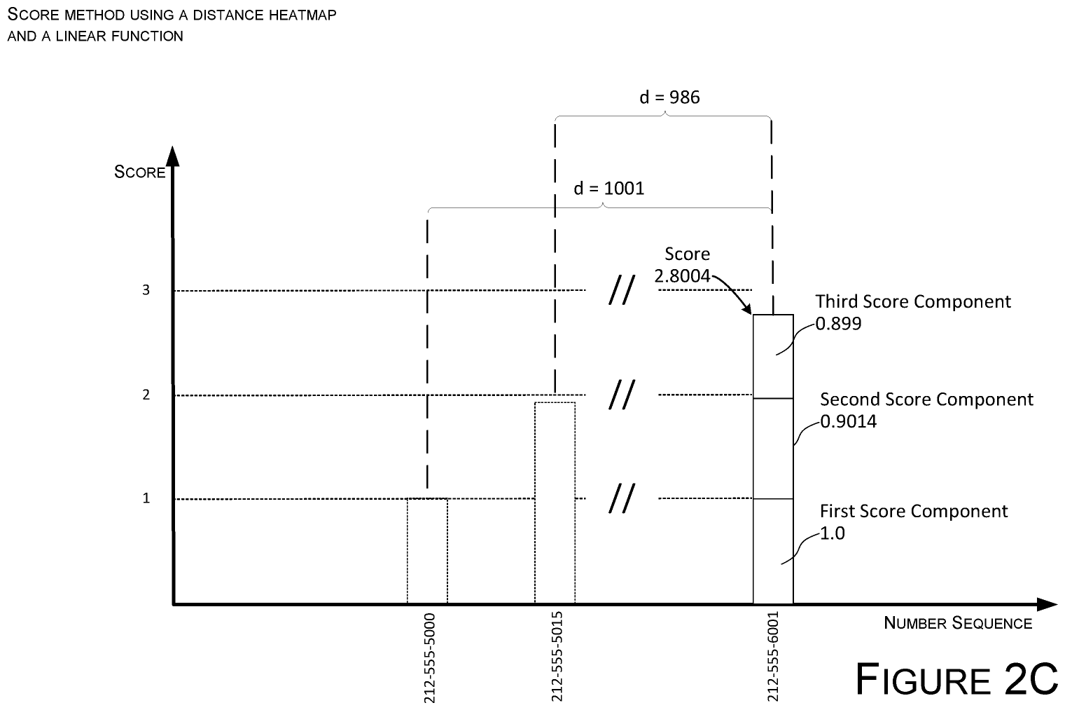

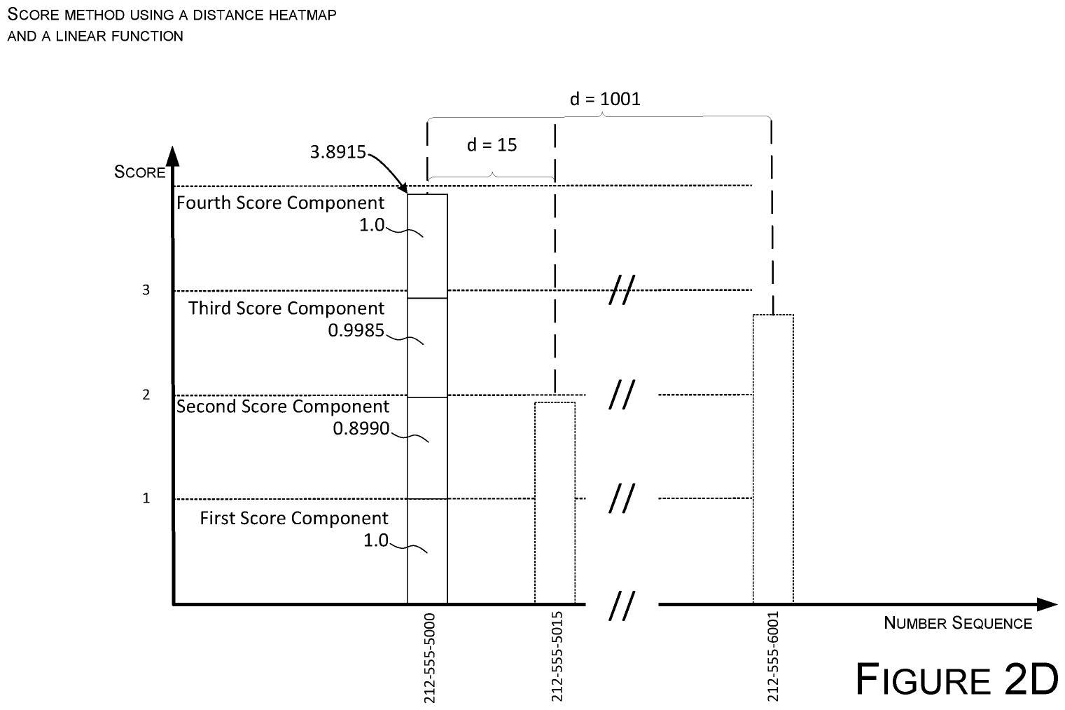

For illustrative purposes, in the example heatmaps of FIGS. 2A through 2D, consider an example where a range of numbers is selected, where the range size is 10,000, and the range of numbers is between 212-555-0000 and 212-555-9999. Each time a message is received, the system generates a score for the number associated with the message. The score is based on that individual message as well as previously received messages that were received within a predetermined time period.

In the beginning of the time period, as shown in FIG. 2A, the system receives a first message for a first phone number, 212-555-5000. In response to the delivery of the first message to the first number, the system generates a score of one (1) for that first phone number. Then, for each subsequent message, the system generates scores for each number that receives a message, and those scores for those numbers are based on a history of messages.

As shown in FIG. 2B, when the system receives a second message for a second number, e.g., 212-555-5015, that second number receives a score of 1+(1−(|212-555-5015−212-555-5000|/10000))=1.9985. For illustrative purposes, this score comprises a first component, 1, where a full point is granted for the second number since the message is received at the second number, e.g., an “exact match.” This score also comprises a second component, (1−(|212-555-5015−212-555-5000|/10000))=0.9985, that is determined by a difference between the phone number of the first message and the phone number of the second message. The absolute value of the difference between the first number and the second number is divided by the number of numbers in the predetermined range.

For each subsequent message, the score for each number receiving a message will have added score components that are each influenced by previously received messages. For instance, as shown in FIG. 2C, when a third message is received at a third number, 212-555-6001, a score for that third phone number in response to the third message will be 1+(1−(|212-555-6001−212-555-5015|/10000))+(1−(|212-555-6001−212-555-5000|/10000))=1+0.9014+0.899=2.8004. The first component of 1 is the full point for the third message being an exact match. The second component of 0.9014 is a value that is determined by a difference between the phone number of the third message and the phone number of the second message. The third component of 0.899 is a value that is determined by a difference between the phone number of the third message and the phone number of the first message. The score for each message is based on all messages received for numbers within the predetermined range and for a predetermined time period.

In continuing the example, as shown in FIG. 2D, if a fourth message is received at the same number as the first message, 212-555-5000, the system will calculate the score based on the history of all of the messages within the predetermined time period, and all numbers within the predetermined range. Thus, in response to a fourth message received at the number, 212-555-5000, the system would determine a score of 1+(1−(|212-555-6001−212-555-5000|/10000))+(1−(|212-555-5015−212-555-5000|/10000))+(1−(|212-555-5000−212-555-5000|/10000))=1+0.899+0.9985+1=3.8975. The first and last score components are a value of 1 since the number associated with the message is an exact match, and the two middle components are based on a difference between the fourth message and the third message, and a difference between the fourth message and the second message. As shown, this disclosed heat map method is different than a process where a score is merely incremented by an integer each time a message is received. This method can reveal fraudulent behavior that is in control of a range of numbers.

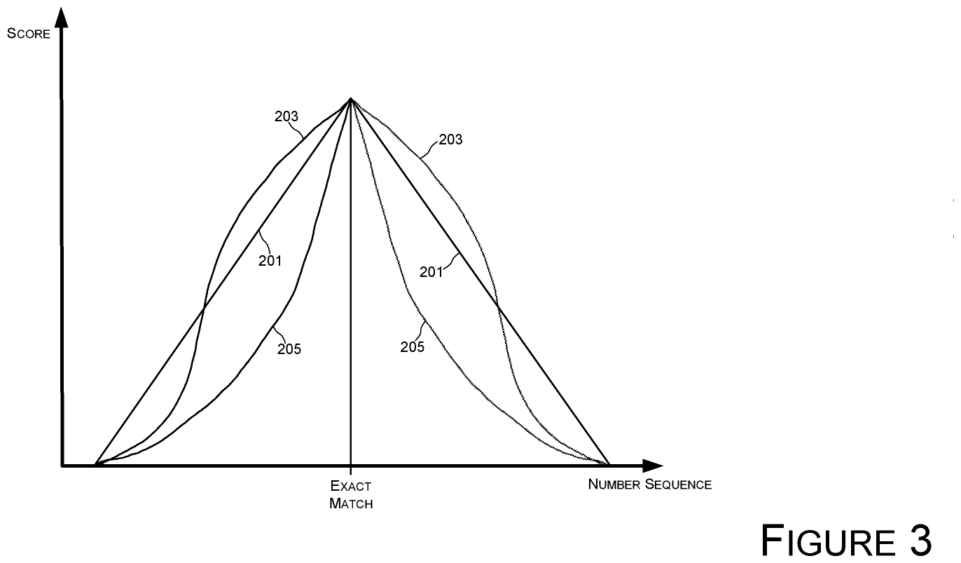

Although this example shows a set of score components that are based on a linear function, e.g., a difference between two numbers divided by a value representing a quantity of phone numbers in a range, it can be appreciated that each score component can be determined by other types of functions, including non-linear functions. Some embodiments can utilize polynomial functions or Bayesian functions to generate different score components that are used to generate an individual score for a number in response to a message. As shown in FIG. 3, the first line 201 shows a representation of a linear function that can be used with the techniques disclosed herein. For example, the distance heatmap embodiments can include a function that utilizes a difference between two numbers divided by a total count of numbers in a range. The second line 203 shows a representation of a first polynomial function. This polynomial function can involve exponentials that cause the generation of a wider bell curve. The third line 205 shows a representation of another polynomial function. This other polynomial function can involve exponentials that cause the generation of a narrower bell curve. The use of such functions can influence the resulting scores that enable a system to identify specific types of behaviors of calling and messaging patterns.

In other embodiments, a system can utilize a ranged heatmap. In the ranged heatmap method, when a message is received for a number, a score for that number is based on several score components: a first score component for having an exact match and additional score components that are weighted based on different ranges of numbers surrounding the number associated with the message. Consider an example where a message is sent to the number 212-555-5000. In this case, the system can generate a first score component for the message to the number plus additional score components for the ranges 212-555-500X, 212-555-50XX, 212-555-5XXX, and 212-555-XXXX. For illustrative purposes, X is a wildcard, e.g., 212-555-500X covers a range of numbers from 212-555-5000 to 212-555-5009. In using this ranged heatmap scoring method, depending on how deep range overlap is desired for evaluation of one or more behavioral message patterns, the wild card can go up to a country code, e.g., up to 212XXXXXXX. The range for each component can be determined by one or more factors, and a weighting for a score component can be determined by one or more factors.

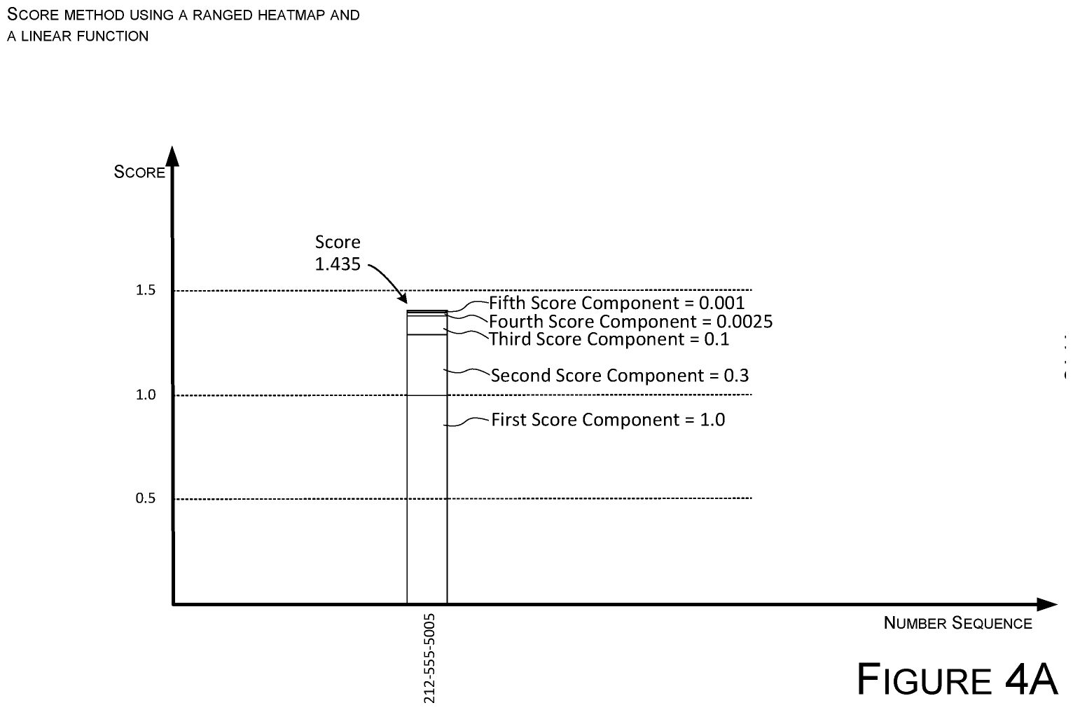

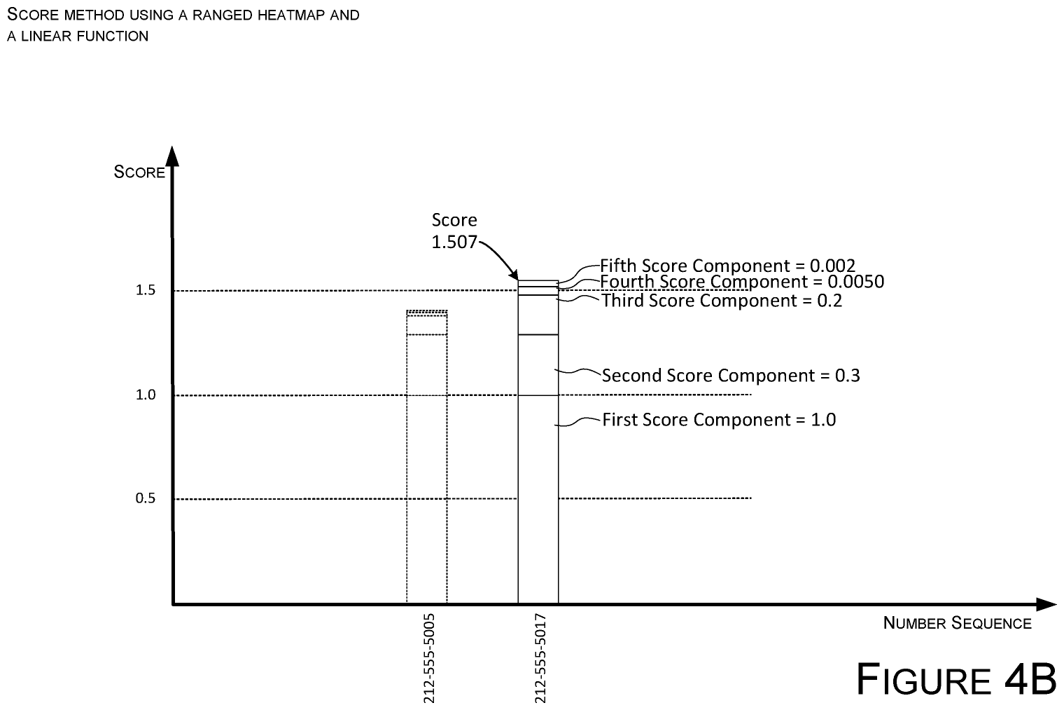

Turning now to FIGS. 4A through 4B, another example shows how a ranged heatmap is used to determine scores in response to messages received at individual numbers. In this illustrative example, consider a scenario where a system is configured to utilize five ranges, e.g., five score components each score component is associated with a particular range. In this example, since there are five score components, the range definitions can go up to four digits. Where a score for a number in response to a message is based on the five score components, where each score component receives:
1 point for each message received at a number having an exact match
0.3 points for each message received at numbers within a number range with 1 wildcard X
0.01 points for each message received at numbers within a number range with 2 wildcards XX
0.0025 points for each message received at numbers within a number range with 3 wildcards XXX
0.0001 points for each message received at numbers within a number range with 4 wildcards XXXX.

As shown, the system can also utilize weighting functions for each range. In this example, the weighting values are 1 for a first range (an exact match), 0.3 for the second range, 0.01 for the third range, 0.0025 for the fourth range, or 0.0001 for the fifth range. These can include weighting values can be the result of any suitable function, including but not limited to a linear function, a polynomial function, etc.

The scores, e.g., the weighting values, 1, 0.3, 0.01, 0.0025, and the 0.0001, can be determined based on behavior and/or expectations. For instance, if a certain area code, region or carrier has a particular calling and/or messaging pattern, a system may select a different score pattern that gives more weight to the different score categories. In one illustrative example, a system may issue 1.5 points for an exact match, 1.25 for points for each message received at numbers within a number range with 1 wildcard X, 1.0 points for each message received at numbers within a number range with 2 wildcards XX, etc. Such a pattern of scores follows a linear function and may be more accurate at detecting a specific behavior versus the other set of scores provided in the other example described above.

As shown in FIG. 4A, if a message is received at 212-555-5005, and the ranges include 212-555-500X, 212-555-50XX, 212-555-5XXX, and 212-555-XXXX for the above equation, the score for that number in response to that first message would be 1*1+1*0.3+1*0.1+1*0.0025+1*0.001=1.435.

In subsequent messages received at individual numbers, the system follows a similar equation for ranges around to that number to determine a score for each subsequent message and each respective number using a message history. Thus, in the present example, as shown in FIG. 4B, when a second message is received at a number 212-555-5017, score components are calculated for each corresponding range 212-555-5017, 212-555-501X, 212-555-50XX, 212-555-5XXX, and 212-555-XXXX. Using the equation noted above, and considering the message history, which includes the first message, the score for 212-555-5017 in response to the second message will be 1*1+1*0.3+2*0.1+2*0.0025+2*0.001=1.507.

As shown, the weighting factors (1, 0.3, 0.1, 0.0025, 0.001) are respectfully multiplied by the number of messages (1, 1, 2, 2, 2) received for each range. Thus, if a third message is received at 212-555-5017, the weighting factors (1, 0.3, 0.1, 0.0025, 0.001) would remain the same but the number of messages received for each range would be (2, 2, 3, 3, 3). In this method, no matter how “far” two numbers are from each other, if they are from the same range, the entire range receives the same score component using the same weighting.

In some embodiments, the system can also add the wildcard, X, to random locations in a number, such as the middle of the number. For example, 212-555-50X7, 212-555-5X17, 212-555-X017, or other combinations. In addition, the system can assign separate scores and different weighting factors for these matches. For example, depending on the volume and/or speed of a database, a system may determine not to associate entities with wildcard assignments and, instead do runtime evaluations. Technically, the algorithm can remain the same and that should be a decision based on performance measurements.

In some embodiments, the system 100 utilizes one or more cooldown techniques. This allows the system to help distinguish activity of parties that are engaging in legitimate behavior and parties engaging in malicious behavior. Embodiments utilizing cooldown techniques utilize a predetermined cooldown period. During that cooldown period, the scores that are generated for each number can be reduced over the cooldown period. The rate in which scores can be reduced over the cooldown period can be based on a selected function type, e.g., linear, non-linear, etc. For example, if a system selects a cooldown period of 24 hours. If a linear decay function is utilized by the system, a number receives a score of six (6) for a message received at Time=0, e.g., received at the start of the cooldown period. However, 12 hours into the cooldown period, e.g., halfway through the cooldown period, the impact of the first message would be half, e.g., three (3). Then later, e.g., 23.5 hours into the cooldown period, the impact of the first message would be close to zero, e.g., 0.02, since the cooldown period is almost over, e.g., the impact of the first message received 23.5 hours ago would be scored by a quantity of messages times a decay function, e.g., 1×(1−23.5/24).

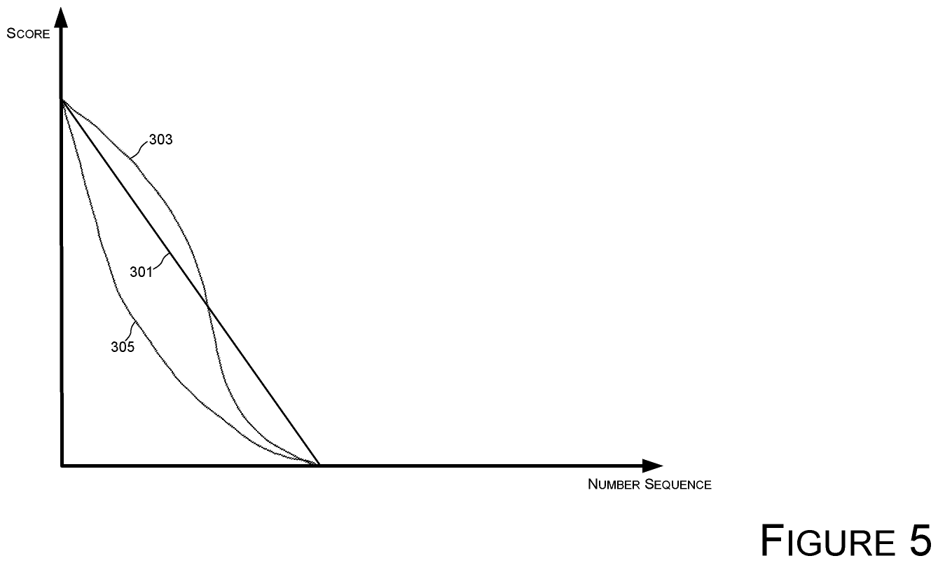

Although this example shows a cooldown period and a linear decay function, the system can use any other type of decay function for the cooldown process. As shown in FIG. 5, the system can utilize a first polynomial function 303 having an initial decay rate that is slower than a linear function 301. Alternatively, the system can utilize a second polynomial function 305 having an initial decay rate that is faster than the linear function 301. These functions are for Illustrative purposes and are not to be construed as limiting. It can be appreciated that different function shapes can be used to identify specific types of behaviors and patterns. Specific types of functions can also be used in different times of the day, different times of the week, etc. Specific types of functions can also be used in different times area codes, country codes, geographic regions, etc. For illustrative purposes, a decay rate is a rate in which a score is reduced over time from a starting time of a cooldown period to the end of a cooldown period.

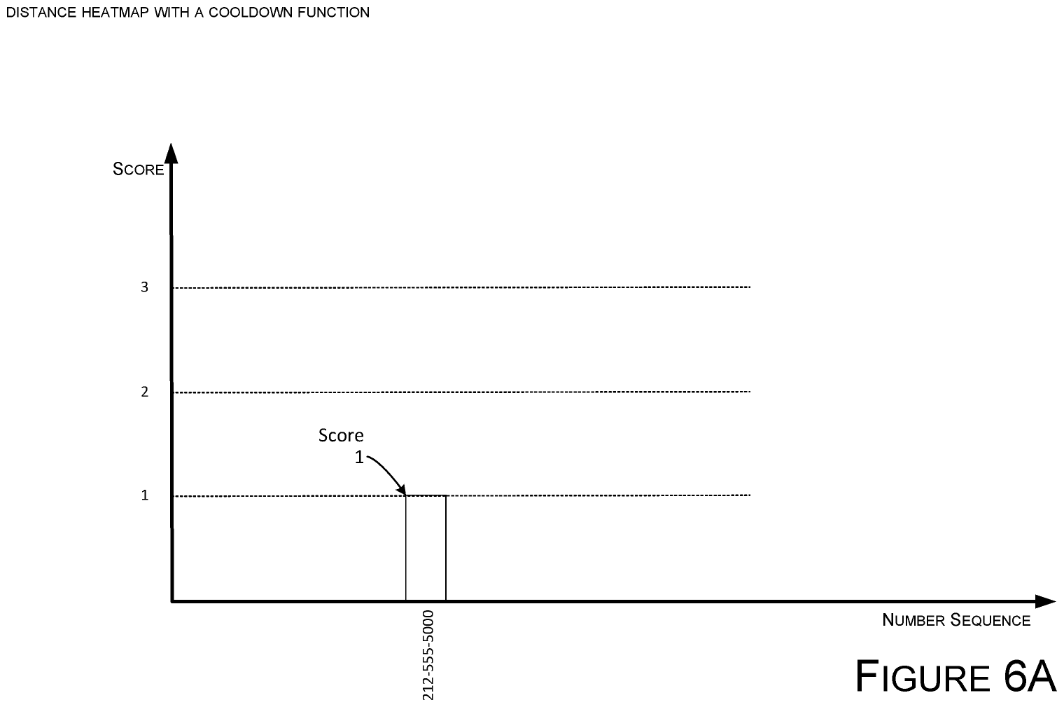

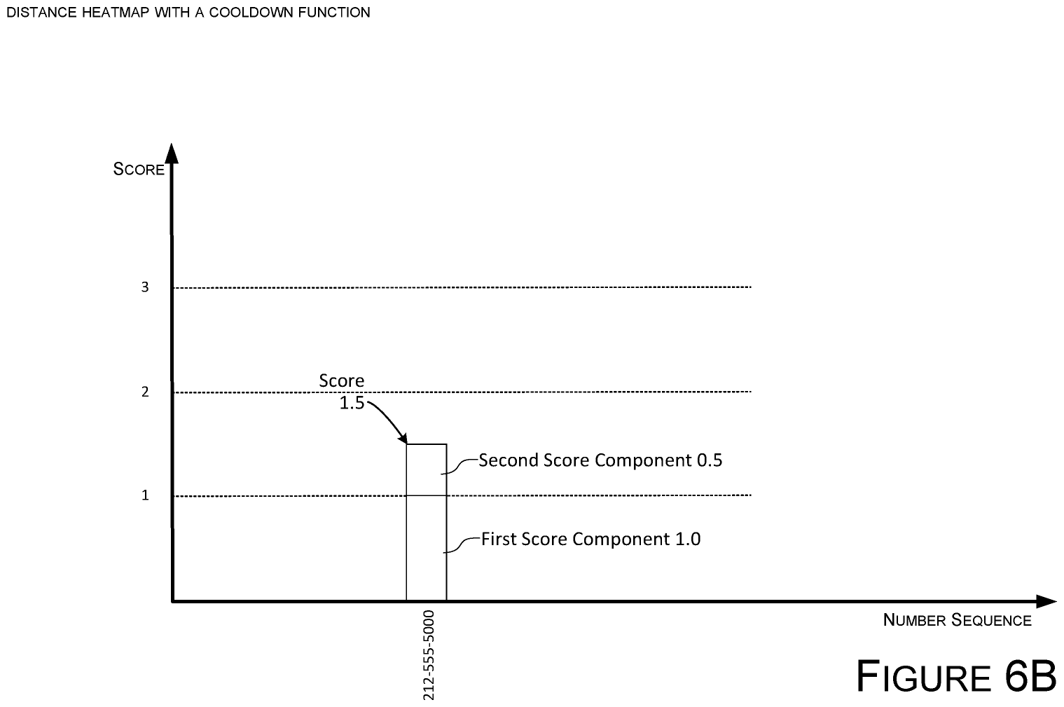

Turning now to FIGS. 6A-6B, an example of a cooldown method is applied to a system utilizing a distance heatmap. In this example, as shown in FIG. 6A, consider a scenario where a time period starts at 10 AM (10:00) and the system is configured to have a cooldown period of 12 hours. When a first message is received at a first number at 10 AM (10:00), the system assigns that number a score of 1.

Then, as shown in FIG. 6B, when the same number receives a second message at 4 PM (16:00), the system assigns a score of 1 (exact match at 10:00)*(1−(6 h/12 h))+1 (exact match at 16:00)=1*0.5+1*1=1.5. The score of 1.5 includes a first component and a second score component. The first component is 1*1 for the second message since the second message is at the current time (the second message has not aged). The second score component is 1*0.5 for the first message since the first message was received 6 hours ago, e.g., halfway through the cooldown period of 12 hours.

For illustrative purposes, consider an alternative scenario where the second message is received at 10:00 PM (22:00), instead of 4 PM. Then the score for that second message would be 1 as the cooldown period would be reset, and there would be no reduction in the score due to the age of a message. Each time the cooldown period is reset, the system does not consider any messages from the message history in a previous cooldown period, and the “age” of any received message is determined from a time that the message is communicated to a phone from a time that the cooldown period started. In the example where the second message is received at 10:00 PM (22:00), instead of 4 PM, the decay multiplier would be 1, e.g., there is no reduction in the score.

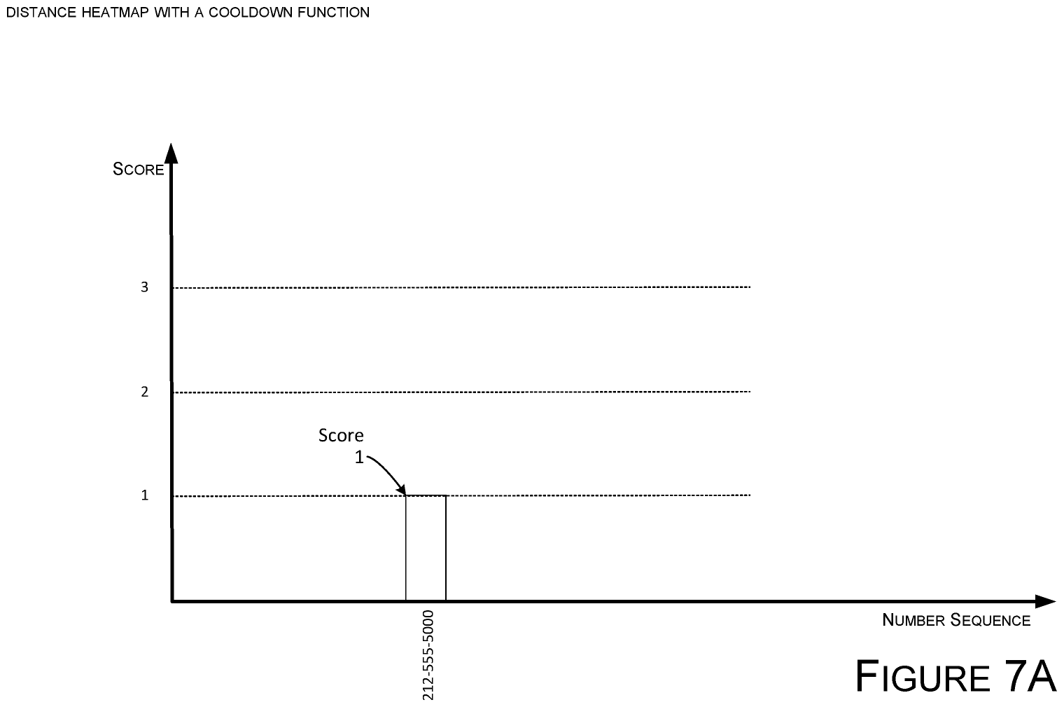

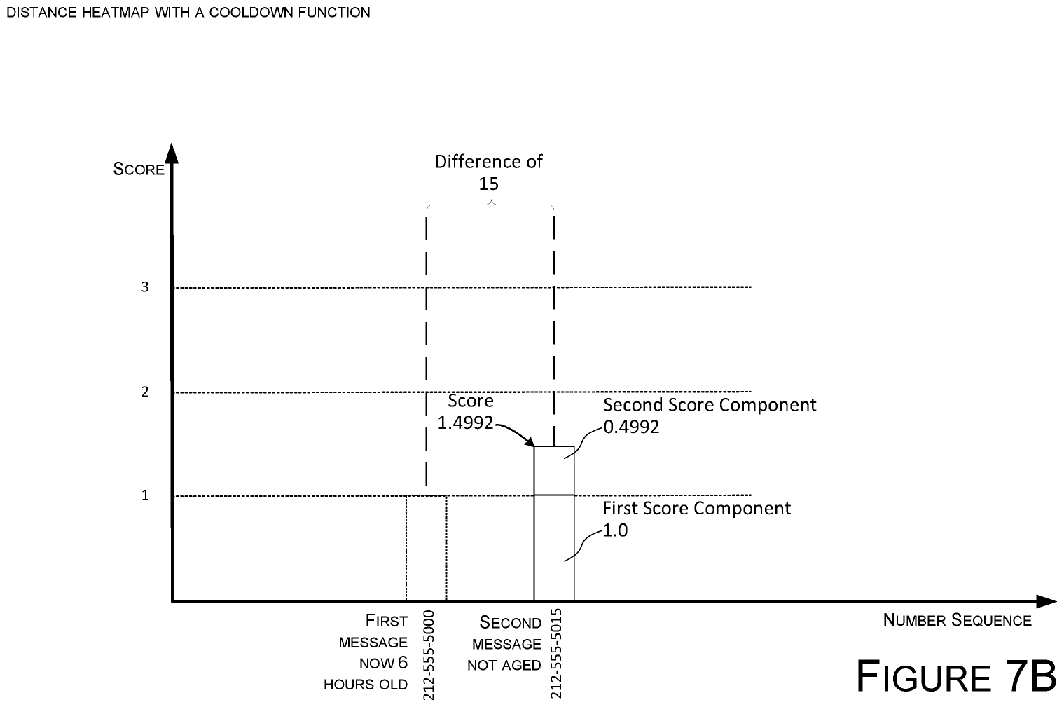

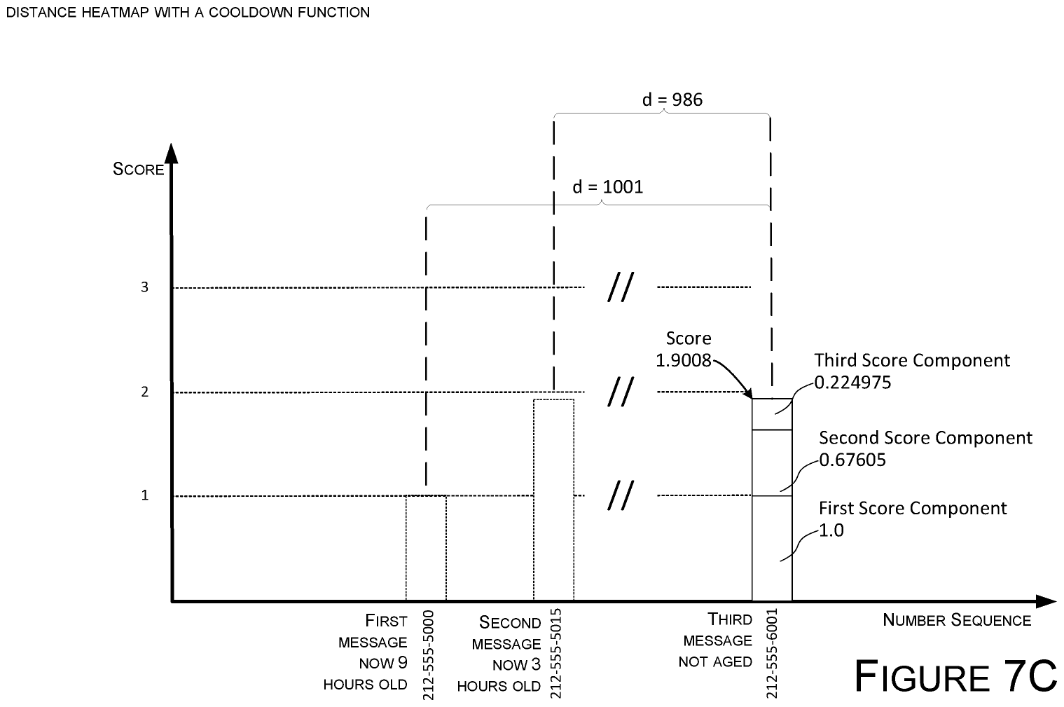

Turning now to FIGS. 7A-7C, another example of the cooldown method is applied to a system utilizing a distance heatmap. In this example, as shown in FIG. 7A, consider a scenario where a cooldown period of 12 hours is selected. In the beginning of the time period, at noon (12:00), the system receives a first message for a first phone number, 212-555-5000. In response to the delivery of the first message to the first number, the system generates a score of one (1) for that first phone number, or 1*(1−(0 h/12 h), where “1” is the score component and “(1−(0 h/12 h)” is the decay factor. The decay factor is based on amount of time that has passed since the start of the cooldown period. Thus, when a score is received after the start of the cooldown period, the score component for older messages within that cooldown period is reduced over time, while a score for a newly received message, e.g., a current message received at a current time, is not reduced in value.

As shown in FIG. 7B, when a second message is received at 6 PM (18:00) for a second number, e.g., 212-555-5015, the system generates a score for that second number, where the score includes a first score component plus a second score component:

The first score component for the second message, which is an exact match to the second number, and 0 hours old:

$$1 * ( 1 - ( 0 h / 12 h )$$

The second score component based on the difference between the second number and the first number (15), and also taking in account that the first message for first number is now 6 hours old:

$$( 1 - ( \vert 212 - 555 - 5015 - 212 - 555 - 5000 \vert / 10000 ) ) * ( 1 - ( 6 h / 12 h )$$

In adding the two score components for the second message, the system generates the score for the second number in response to the second message as:

$${1}_{First Score Component} + {0.9985 * 0.5}_{Second Score Component} = 1.4992$$

As shown, the impact of the first message is reduced as time continues. In this example, the impact of the first message is reduced linearly up to 12 hours. When the first message is 12 hours old, the impact of that old message to the first number is zero. In this case, at the time of the second message, the impact of the first message is reduced by 50%.

As shown in FIG. 7C, when a third message is received at 9 PM (21:00) at a third number, 212-555-6001, the system generates a score for that third number, where the score for the third number includes a first score component, a second score component and a third score component:

The first score component for the third message, which is an exact match to the third number, and 0 hours old:

$$1 * ( 1 - ( 0 h / 12 h )$$

The second score component for the third message is based on (a) the difference between the third number and the second number (986), and also (b) considering that the second message for the second number is now 3 hours old:

$$( 1 - ( \vert 212 - 555 - 6001 - 212 - 555 - 5015 \vert / 10000 ) ) * ( 1 - ( 3 h / 12 h )$$

The third score component for the third message is based on (a) the difference between the third number and the first number (1001), and also considering that the first message is now 9 hours old:

$$( 1 - ( \vert 212 - 555 - 6001 - 212 - 555 - 5000 \vert / 10000 ) ) * ( 1 - ( 9 h / 12 h )$$

In adding the score components for the third message, the system generates the score for the third number in response to the third message as:

$${1}_{First Score Component} + {0.9014 ( \text{.75} )}_{Second Score Component} + {0.8999 ( \text{.25} )}_{Third Score Component} = 1.9008$$

As shown, as each message in the history ages, the impact they have on incoming messages is reduced. This enables the system to identify certain types of malicious behavior, while allowing permitted behaviors.

When comparing the scores generated in the example of FIGS. 7A-7C, compared to the scores generated in the example of FIGS. 2A-2C, the results generated by the embodiments using the cooldown techniques can allow the system to be less influenced, e.g., “forget,” older messages. This enables the system to accommodate higher volume users/entities participating in legitimate practices, while still allowing the system to detect malicious practices. More specifically, the system can detect malicious practices that operate in a range of numbers and also that operate within a given timeframe. Thus, all embodiments disclosed herein can involve the selection of a predetermined range of numbers and utilize the disclosed techniques exclusively within that a predetermined range of numbers.

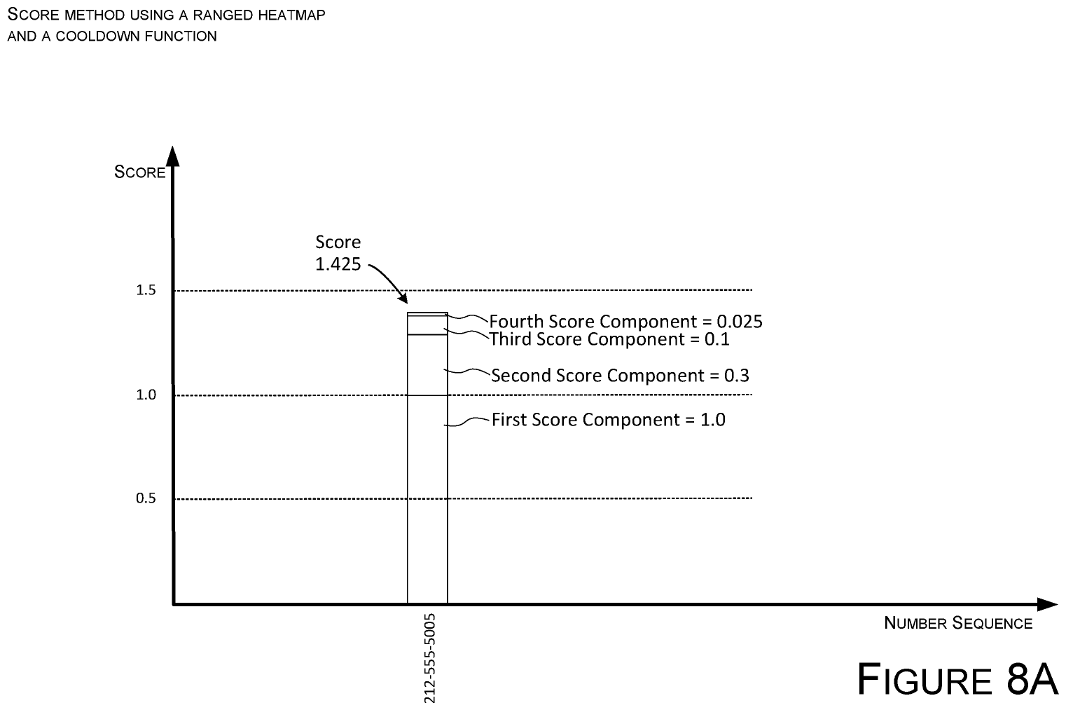

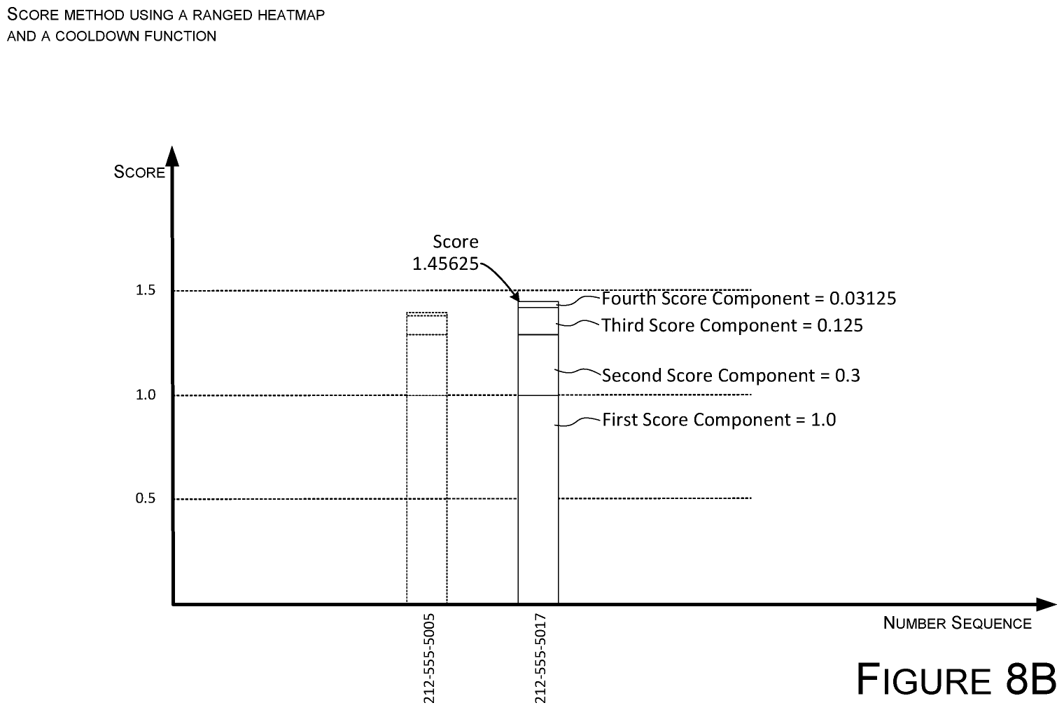

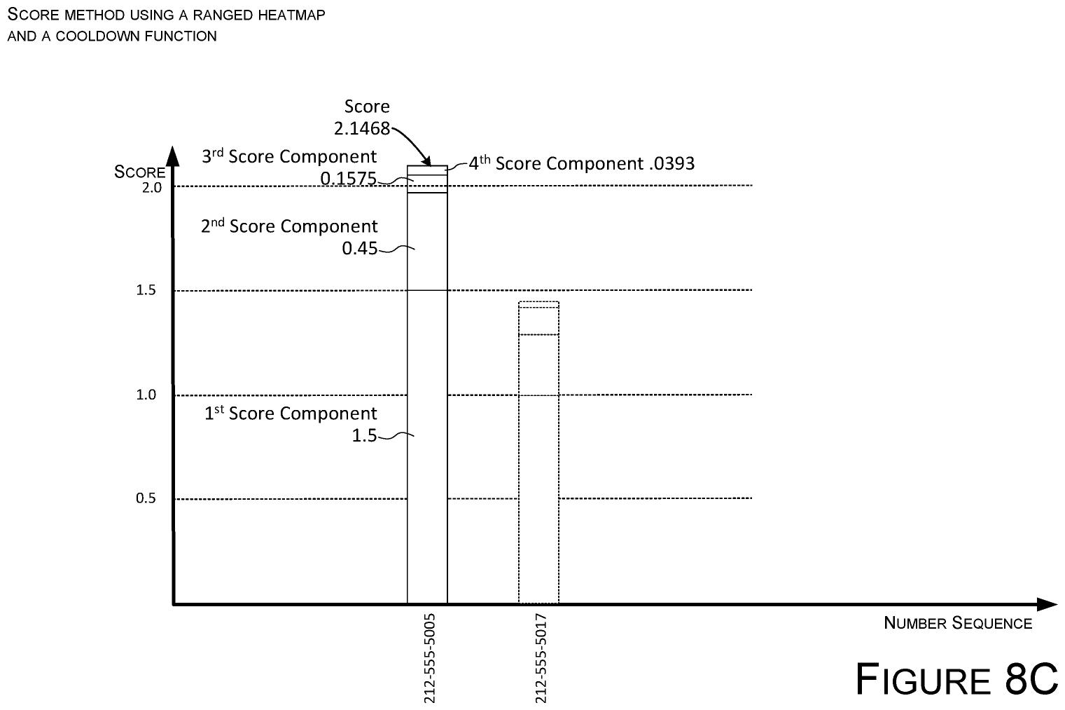

Turning now to FIGS. 8A-8C, an example of a cooldown process involving a ranged heatmap is shown and described below. In this example, consider a scenario where the system utilizes a decay period of 12 hours, e.g., from noon till midnight. In addition, the system is configured to utilize functions to determine scores based on a message history.

In addition, the system generates a score in response to a message received at an individual number. The system can access a call history list. In addition, in this example, the score includes four score components:
1 point for each message received at a number having an exact match
0.3 points for each message received at numbers within a range with one wildcard X
0.1 points for each message received at numbers within a range with two wildcards XX
0.025 points for each message received at numbers within a range with three wildcards XXX

In this example, each score component has a multiplier, e.g., 1, 0.3, 0.1, and 0.025, which can include a set of predetermined multipliers. Alternatively, the multipliers can be based on a function, which can be represented by a curve of a linear function or an exponential function, such as the functions shown in FIG. 5.

In this example, consider the message activity shown in this historical message log shown in TABLE 1.

TABLE 1

| Message number | Time | Recipient phone number |
|---|---|---|
| 1 | 12:00 (noon) | 212-555-5005 |
| 2 | 3:00 PM | 212-555-5017 |
| 3 | 6:00 PM | 212-555-5005 |

In response to receiving the first message at 212-555-5005 at noon, as shown in FIG. 8A and TABLE 2 below, the system generates a score of 1.425 because the first message is the only message influencing the score and the message is new, e.g., the message has not aged relative a percentage of the cooldown period. The system determines the score for the first number in response to the first message according to TABLE 2. As shown in the second row, the number meets the criteria for all ranges, e.g., the number 212-555-5005 also falls within each range defined by the wildcards. Thus, the multiplier, e.g., the function, of each component, e.g., 1, 0.3, 0.1, 0.025 is multiplied by a quantity of 1, which is the number of messages received for each range according to the message history at this point in time. In addition, since the message is new, e.g., sent at noon, the cooldown multiplier is (1−(0 h/12 h)=1, since the message is received at the start of the cooldown period (also referred to herein as the decay period), e.g., the message has not aged. Score for first message received at noon at number 212-555-5005

TABLE 2

| | 212-555- | 212-555- | 212-555- | 212-555- | Total |
|---|---|---|---|---|---|
| | 5005 | 500X | 50XX | 5XXX | Score |
| Impact of first | 1 × 1 | 1 × 0.3 | 1 × 0.1 | 1 × 0.025 | |
| message to | | | | | |
| 212-555-5005 | | | | | |
| Cooldown | 1 | 1 | 1 | 1 | |
| Multiplier | | | | | |
| Total | 1 | 0.3 | 0.1 | 0.025 | 1.425 |

Then, in response to receiving the second message at 212-555-5017 at 3 PM, the system generates a score of 1.4281 because there are now two messages that influence the score: one message from 212-555-5005 and 212-555-5017. In addition, the message for 212-555-5005 is now 3 hours old, and the message for 212-555-5017 is new, e.g., the new message has not aged. As shown as shown TABLE 3 and FIG. 8B, the message that is three hours old now has less of an impact to the total score.

### Score for Second Message Received at 3 PM at Number 212-555-5017

TBALE 3

| | 212-555- | 212-555- | 212-555- | 212-555- | Total |
|---|---|---|---|---|---|
| | 5017 | 501X | 50XX | 5XXX | Score |
| Range match for | 1 × 1 | 1 × 0.3 | 1 × 0.1 | 1 × 0.025 | |
| 212-555-5017 at | | | | | |
| 3:00 | | | | | |
| Cooldown | 1 | 1 | 1 | 1 | |
| Multiplier | | | | | |
| (message not | | | | | |
| aged) | | | | | |
| Impact of message | 1 | 0.3 | 0.1 | 0.025 | 1.425 |
| to 212-555-5017 | | | | | |
| at 3:00 | | | | | |
| Range match for | 0 × 1 | 0 × 0.3 | 1 × 0.1 | 1 × 0.025 | |
| 212-555-5005 | | | | | |
| at 12:00 | | | | | |
| Cooldown | (1 − (3 | (1 − (3 | (1 − (3 | (1 − (3 | |
| Multiplier | h/12 h) | h/12 h) | h/12 h) | h/12 h) | |
| (3 hours old) | | | | | |
| Impact of message | 0 | 0 | 0.025 | 0.00625 | .03125 |
| to 212-555-5005 | | | | | |
| at 12:00 | | | | | |
| Score Total in | 1 | .3 | 0.125 | 0.03125 | 1.45625 |
| response to 3 PM | | | | | |
| message | | | | | |

Then, in response to receiving the third message at 212-555-5005 at 6 PM, the system generates a score of 2.1468. This score is influenced by three messages: a first message for 212-555-5005, a second message to 212-555-5017, and another message to 212-555-5005. In addition, the first message for 212-555-5005 is now 6 hours old, and the second message for 212-555-5017 is now 3 hours old. The messages that are three and six hours old have less of an impact to the total score, as shown TABLE 4 and FIG. 8C.

Score for a third message received at 6 PM at number 212-555-5005, e.g., a second time a message is received at the first number.

TABLE 4

| | 212-555- | 212-555- | 212-555- | 212-555- | Total |
|---|---|---|---|---|---|
| | 5005 | 500X | 50XX | 5XXX | Score |
| Range match for | 1 × 1 | 1 × 0.3 | 1 × 0.1 | 1 × 0.025 | |
| 212-555-5005 at | | | | | |
| 18:00 | | | | | |
| Cooldown | (1 − (0 h/12 h) | (1 − (0 h/12 h) | (1 − (0 h/12 h) | (1 − (0 h/12 h) | |
| Multiplier | | | | | |
| (message not | | | | | |
| aged) | | | | | |
| Impact of message | 1 | 0.3 | 0.1 | 0.025 | 1.425 |
| to | | | | | |
| 212-555-5005 at | | | | | |
| 18:00 | | | | | |
| Range match for | 0 × 1 | 0 × 0.3 | 1 × 0.1 | 1 × 0.025 | |
| 212-555-5017 at | | | | | |
| 3:00 | | | | | |
| Cooldown | (1 − (3 h/12 h) | (1 − (3 h/12 h) | (1 − (3 h/12 h) | (1 − (3 h/12 h) | |
| Multiplier (3 | | | | | |
| hours old) | | | | | |
| Impact of message | 0 | 0 | 0.0075 | 0.001875 | .009375 |
| to | | | | | |
| 212-555-5017 at | | | | | |
| 3:00 | | | | | |
| Range match for | 1 × 1 | 1 × 0.3 | 1 × 0.1 | 1 × 0.025 | |
| 212-555-5005 at | | | | | |
| 12:00 | | | | | |
| Cooldown | (1 − (6 h/12 h) | (1 − (6 h/12 h) | (1 − (6 h/12 h) | (1 − (6 h/12 h) | |
| Multiplier (6 | | | | | |
| hours old) | | | | | |
| Impact of message | 0.5 | 0.15 | 0.05 | 0.0125 | 0.7125 |
| to | | | | | |
| 212-555-5005 at | | | | | |
| 12:00 | | | | | |
| Score Total in | 1.5 | 0.45 | .1575 | 0.039375 | 2.1468 |
| response to 3 PM | | | | | |
| message | | | | | |

As shown in this example, the older a message becomes, the less of an impact that a message to that number becomes. Eventually, after the predetermined decay period, e.g., 12 hours, those older messages will not impact the overall score. Thus, if there is a large volume of messages between 12:01 and 12:10 boosting the score for a short time period, e.g., 20 minutes, a security measure be implemented. However, if that same volume is spread out over the cooldown time period, the security measure may not be implemented because of the cooldown effect of the older messages. This allows for some types of behavior, which may be a high level of activity but not deemed as malicious. This can be particularly helpful in a situation where a fixed threshold is used to trigger a security measure. For example, in the prior example, if a threshold was set at 3, and the system received the same pattern of messages within the first hour of the cooldown period, the system would have invoked a security measure because the score for the third message would have been above 3. But in the scenario described above, where the three messages were spread out over a 12 hour period, the security measure is not triggered, as the score stayed below a threshold of 3.

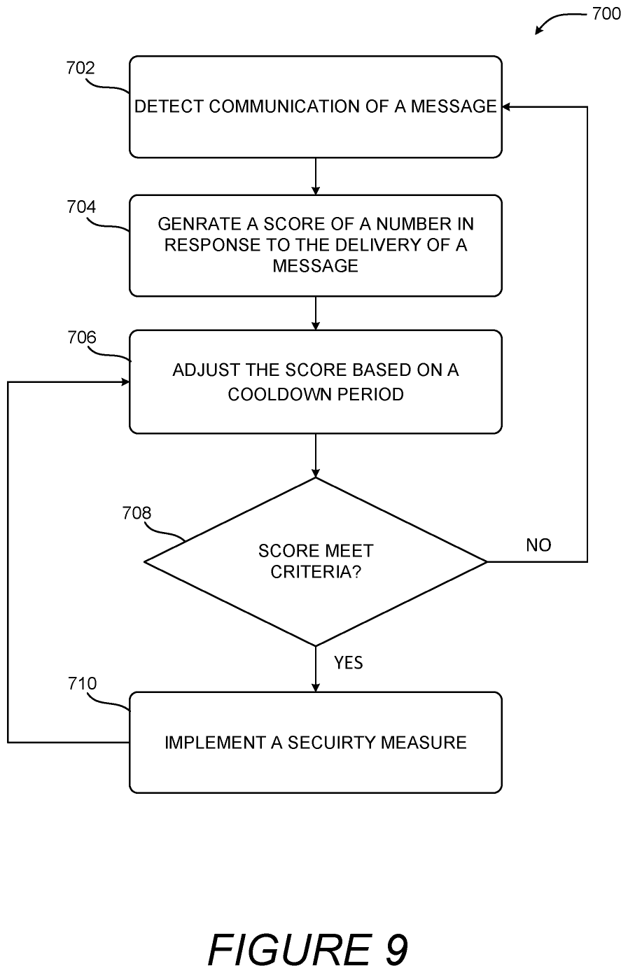

Turning now to FIG. 9, aspects of a routine 700 providing enhanced security in a system utilizing an activity heatmap with cooldown adjustments are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor of another remote computer or a local circuit. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

In operation 702, the service 110 detects communication of individual messages directed to individual phone numbers of a plurality of phone numbers. This can be done when a software application sends instructions to send a text to a device or when instructions are sent to the PSTN to send a text message. The service can also detect instructions from other devices or systems that initiate text messages or calls to any mobile device. For illustrative purposes, all of the techniques disclosure and also apply to phone calls, text messages, and any other communication channel that initiates contact or communicates data. So the system can detect when phone calls are made or when the communication of any type of message is detected, including but no limited to WhatsApp messages, Facebook Messenger messages, etc.

In operation 704, the service 110 determines individual scores for individual phone numbers of the plurality of phone numbers in response to the service detecting the communication of the individual messages. An individual score for an individual phone number is based on the activity heatmap defining a number of messages directed to the individual phone number and a number of messages directed to other phone numbers associated with the individual number.

In using a distance heatmap, as shown in FIGS. 2A-2D, the individual score for an individual phone number comprises a plurality of score components including a first score component and other score components. The first score component is based on the number of messages directed to the individual phone number. The other score components are based on the number of messages directed to the other phone numbers and a difference between the other phone numbers and the individual phone number.

In using a ranged heatmap, as shown in FIGS. 4A-4B, the individual score for an individual phone number comprises a plurality of score components, including a first score component and other score components. The first score component is based on the number of messages directed to the individual phone number. The other score components are based on the number of messages directed to the other phone numbers. The number of messages directed to the other phone numbers influence the other score components if the other phone numbers have a threshold number of common phone number digits with the individual phone number. For example, a first phone number can have a threshold number of common phone number digits with a second number if the first phone number is 212-555-5005 and the second phone number is 212-555-5017 and the threshold is determined by a filter, 212-555-50XX. In this example, the filter requires that the numbers have at least have the same first seven digits, e.g., the threshold number of common phone number digits. If a message is received at the first number, and since the second number has the threshold number of common phone number digits with the first number, a number of messages at the second number will be counted in a second score component. For other numbers that do not meet this criterion, a number of messages received at those other numbers that do not meet this criteria do not influence a score.

In some embodiments, in determining scores in response to a message, the phone numbers surrounding a number receiving a message can include numbers that are either within a range or within a distance of the number. Thus, in the routine, an individual phone number is associated with the other phone numbers when the other phone numbers are within a predetermined range of numbers from the individual phone number, or the individual phone number is associated with the other phone numbers when the individual phone number and the other phone numbers are both within the predetermined range of numbers, or the individual phone number is associated with the other phone numbers when the individual phone number and the other phone numbers have a threshold number of common numbers or common number combinations.

In some embodiments, a combination of different communication channels can contribute to a score. For example, if activity to one number involves a number of phone calls, a number of SMS messages, and a number of WhatsApp messages, a score can be generated using the total count of these messages and calls. In another example, one score for a number can be based on an SMS and a call history within one algorithm. This can use distance heatmap, ranged heatmap, or any of these methods with a cooldown period. The score components can also be weighted according to a price per call or price per message. For example, consider a scenario where a SMS message costs is $0.10 in one particular country but a call costs $0.20. In this scenario, the score component for SMS messages could be less than the score component for a call, e.g., a score component would be multiplied by 2 times for each call and multiplied by 1 for each messages. This adjustment can apply to call linear and non-linear functions.

In operation 706, the system adjusts the individual score for the individual phone number based on an age of messages directed to the individual phone number and the other numbers that meets one more criteria with respect to the individual number. The adjustment to the individual score includes reducing the score based on the age of the messages from the start of a cooldown period and a predetermined decay rate. The adjustment can be made during the determination of the score or the adjustment can be made after a score is determined.

In some embodiments, the decay rate can be based on linear or non-linear functions controlling rate of the score reduction. Thus, in the routine, the adjustment to the individual score includes reducing the score based on the age of the messages from a time the messages are received to a start time of a cooldown period, the predetermined decay rate, and a selected function, wherein the selected function is a linear function or a polynomial function.

Although the examples described herein show a cooldown time period and a linear decay function, the system can use any other type of decay function for the cooldown process. The system can utilize a first polynomial function having a slow initial decay rate or a second polynomial function that having a faster initial decay rate. These functions are for Illustrative purposes and are not to be construed as limiting. It can be appreciated that different function shapes can be used to identify specific types of behaviors and patterns.

In using the distance heatmap method with a cooldown feature, as shown in FIGS. 7A-7C, the individual score for an individual phone number comprises a plurality of score components, including a first score component and other score components. The first score component is based on the number of messages directed to the individual phone number, wherein the first score component is further based on an age of individual messages directed to the individual phone number, wherein the other score components are based on the number of messages directed to the other phone numbers and a difference between the other phone numbers and the individual phone number, wherein the other score components are further based on an age of individual messages directed to the other phone numbers.

In using a ranged heatmap with a cooldown feature, as shown in FIGS. 8A-8C, the individual score for an individual phone number comprises a plurality of score components including: a first score component and other score components. The first score component is based on the number of messages directed to the individual phone number. The first score component is also based on an age of individual messages directed to the individual phone number. The other score components are based on the number of messages directed to the other phone numbers. The number of messages directed to the other phone numbers influence the other score components if the other phone numbers have a threshold number of common phone number digits with the individual phone number. The other score components are further based on an age of individual messages directed to the other phone numbers. Operation 706 can also include the use of the filter described above to determine if messages received at the other phone numbers influence the other score components.

At operation 708, the service determines if the individual score for an individual phone number meets one or more criteria with respect to a security threshold. If the individual score for an individual phone number meets one or more criteria with respect to the security threshold, the routine proceeds to operation 710, where the service invokes one or more security measures. If the individual score for an individual phone number does not meet one or more criteria with respect to the security threshold, the routine proceeds back to operation 702, where the service monitors the activity of messages sent to a predetermined set of phone numbers, or a range of phone numbers. For example, if the score shown in FIG. 8C were to exceed a security threshold of 2.0, the routine would proceed to operation 710, where the service invokes one or more security measures.

In operation 708, the determination of whether criteria is met can also be based on an area code or a geographic region. For example, the system may only monitor phone numbers that are limited to at least one of phone numbers within a predetermined range, phone numbers have a predetermined area code, or phone numbers within a predetermined geographic region. In some embodiments, different regions can also have different security thresholds. For instance, a first area code defined by the first three digits of the phone number, or a first region defined by the first six digits of a phone number, can have a first security threshold based on past calling patterns. Depending on a country, code can be from 1 to 3 digits long. For example, in the US it is 1 digit (+1), in Estonia—it is 3 (+372), etc. Another region can have a different security threshold. In some embodiments, the security threshold can be adjusted in each iteration of the routine. For instance, if it is determined that there are over a threshold number of false positive notifications of fraudulent behavior, the system may raise a security threshold in future iterations of the routine or future cooldown periods. In another example, if it is determined that there are less than a threshold number of false negative notifications of fraudulent behavior, the system may lower a security threshold in future iterations of the routine or future cooldown periods.

The techniques disclosed herein also allow regions and carriers to compare and evaluate statistics across select regions and/or carriers. These statistics for calling and messaging behavior can be aggregated or averaged to determine security thresholds that may also be averaged or aggregated. For instance, if two carriers have different sets of statistics on call and message volumes, those carriers can combine those sets of statistics to determine a shared threshold that is used to determine when a security measure is to be invoked.

At operation 710, in response to determining that the individual score for the individual phone number meets one or more criteria with respect to a security threshold, the service invokes a security measure for the individual phone number. The security measure includes at least one of generating a notification to a manager of the service, causing the service to require accounts associated with the individual phone number to utilize other alternative message systems, or requiring accounts associated with the individual phone number to upgrade permissions.

A notification can be in the form of a user interface notification, an alarm, a message or an audible alert. In embodiments where the service requires accounts associated with the individual phone number to utilize other alternative message systems, the service can cause a user associated with the individual phone number to use emails for functions, such as a F2A process. Other alternative methods can be utilized, e.g., any form of messaging that does not incur a cost on a per message basis. In embodiments where the service requires accounts associated with the individual phone number to upgrade permissions, the service may require a user or entity to subscribe to a higher level of service, e.g., a paid service, that changes the permissions of the user to send a higher volume of messages, e.g., the security threshold for that account can be increased.

The system may trigger a security measure when a score exceeds a threshold. This can activate any security measure when a score in response to a message causes the generation of a score that is above a predetermined threshold, also referred to herein as a triggering threshold. In another embodiment, the system may trigger a security measure when a score exceeds a threshold for a threshold time. That way, even if a score exceeds a threshold, a security measure is not triggered until that score remains above that threshold for a period of time or over the course of a predetermined number of messages. That way, an anomaly that's triggered by a short-term pattern of calls will not create a false alarm until that pattern is sustained for some time. These features using the cooldown period allow a system to slowly decrease the score over time, thus allowing a system to allow for a certain pattern of traffic, thereby reducing the number of false alarms for malicious behavior.

At operation 710, in response to determining that the individual score for the individual identifier does not meet the one or more criteria with respect to the security threshold, the system may restrict an application of the security measure for the individual identifier and maintain permissions for an account associated with the identifier to continue sending messages or initiating phone calls.

In some embodiments, once a party, e.g., an associated account has been identified as engaging in abusive behavior, it is not always optimal for a system to maintain a penalty forever. The cooldown techniques help keep certain activity away from being deemed as malicious, and when malicious behavior is identified, the system can remove any invoked penalty at certain times and when certain behaviors have subsided below a threshold.

A security measure can also be revoked or deactivated in response to one or more events. In example, a security measure can be deactivated once a party changes a status of their account. For example, in response to a party subscription for an upgraded service where they are paying for at least a part of the messages, the system can remove the security measure and allow the system to send messages, e.g., SMS messages, to an account. In another example, if a triggering event, e.g., scores for a range of numbers settles below a threshold, or settles below a threshold for a period of time, the system can revoke or deactivate the security measure.

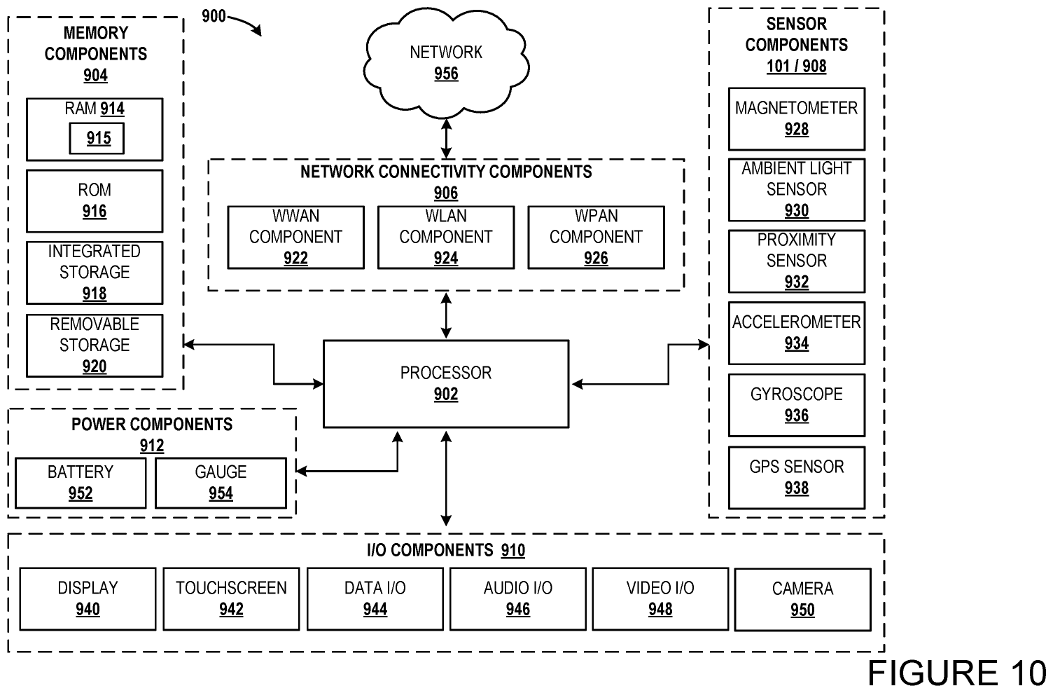

Turning now to FIG. 10, an illustrative computing device architecture 900 for a computing device that is capable of executing various software components described herein. The computing device can be a computer or any hardware unit. The computing device architecture 900 is applicable to computing devices that facilitate computing described herein. The computing device architecture 900 can be the architecture of the service 110, the PSTN 120 or the mobile devices 101 of FIG. 1. In some configurations, the computing devices include, but are not limited to, servers, devices, consoles, etc. The computing device architecture 900 can also apply to any other device that may use or implement parts of the present disclosure, including, but not limited to, mobile telephones, tablet devices, slate devices, portable video game devices, and the like. Moreover, aspects of the computing device architecture 900 may be applicable to traditional desktop computers, portable computers (e.g., laptops, notebooks, ultra-portables, and netbooks), server computers, and other computer systems, such as those described herein.

The computing device architecture 900 illustrated in FIG. 10 includes a processor 902, memory components 904, network connectivity components 906, sensor components 908, input/output components 912, and power components 912. In the illustrated configuration, the processor 902 is in communication with the memory components 904, the network connectivity components 906, the sensor components 908, the input/output (“I/O”) components 910, and the power components 912. Although no connections are shown between the individuals components illustrated in FIG. 10, the components can interact to carry out device functions. In some configurations, the components are arranged so as to communicate via one or more busses (represented by one or more lines between the components).

The memory components 904 is connected to the CPU 902 through a mass storage controller (not shown) and a bus. The memory components 904 and its associated computer-readable media provide non-volatile storage for the computer architecture 900. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, the computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 900. For purposes the claims, the phrase “computer storage device,” “computer storage medium,” “computer-readable storage medium,” “computer-readable storage device,” “non-transitory computer storage media” and variations thereof, does not include waves, signals, and/or other transitory and/or intangible communication media, per se. A storage device can include any type of solid state drive, optical drive, or a rotating media drive.

The processor 902 includes a central processing unit (“CPU”) configured to process data, execute computer-executable instructions of one or more application programs, and communicate with other components of the computing device architecture 900 in order to perform various functionality described herein. The processor 902 may be utilized to execute aspects of the software components presented herein and, particularly, those that utilize, at least in part, a touch-enabled input.

In some configurations, the processor 902 includes a graphics processing unit (“GPU”) configured to accelerate operations performed by the CPU, including, but not limited to, operations performed by executing general-purpose scientific and/or engineering computing applications, as well as graphics-intensive computing applications such as high-resolution video (e.g., 720P, 1030P, and higher resolution), video games, three-dimensional (“3D”) modeling applications, and the like. In some configurations, the processor 902 is configured to communicate with a discrete GPU (not shown). In any case, the CPU and GPU may be configured in accordance with a co-processing CPU/GPU computing model, wherein the sequential part of an application executes on the CPU and the computationally intensive part is accelerated by the GPU.

In some configurations, the processor 902 is, or is included in, a system-on-chip (“SoC”) along with one or more of the other components described herein below. For example, the SoC may include the processor 902, a GPU, one or more of the network connectivity components 906, and one or more of the sensor components 908. In some configurations, the processor 902 is fabricated, in part, utilizing a package-on-package (“PoP”) integrated circuit packaging technique. The processor 902 may be a single core or multi-core processor.

The processor 902 may be created in accordance with an ARM architecture, available for license from ARM HOLDINGS of Cambridge, United Kingdom. Alternatively, the processor 902 may be created in accordance with an x86 architecture, such as is available from INTEL CORPORATION of Mountain View, California and others. In some configurations, the processor 902 is a SNAPDRAGON SoC, available from QUALCOMM of San Diego, California, a TEGRA SoC, available from NVIDIA of Santa Clara, California, a HUMMINGBIRD SoC, available from SAMSUNG of Seoul, South Korea, an Open Multimedia Application Platform (“OMAP”) SoC, available from TEXAS INSTRUMENTS of Dallas, Texas, a customized version of any of the above SoCs, or a proprietary SoC.

The memory components 904 include random access memory (“RAM”) 914, read-only memory (“ROM”) 916, an integrated storage memory (“integrated storage”) 918, or a removable storage memory (“removable storage”) 920. In some configurations, the RAM 914 or a portion thereof, the ROM 916 or a portion thereof, and/or some combination the RAM 914 and the ROM 916 is integrated in the processor 902. In some configurations, the ROM 916 is configured to store a firmware, an operating system or a portion thereof (e.g., operating system kernel), and/or a bootloader to load an operating system kernel from the integrated storage 918 and/or the removable storage 920. The RAM or any other component can also store the device module 915 or other software modules for causing execution of the operations described herein.

The integrated storage 918 can include a solid-state memory, a hard disk, or a combination of solid-state memory and a hard disk. The integrated storage 918 may be soldered or otherwise connected to a logic board upon which the processor 902 and other components described herein also may be connected. As such, the integrated storage 918 is integrated in the computing device. The integrated storage 918 is configured to store an operating system or portions thereof, application programs, data, and other software components described herein.

The removable storage 920 can include a solid-state memory, a hard disk, or a combination of solid-state memory and a hard disk. In some configurations, the removable storage 920 is provided in lieu of the integrated storage 918. In other configurations, the removable storage 920 is provided as additional optional storage. In some configurations, the removable storage 920 is logically combined with the integrated storage 918 such that the total available storage is made available as a total combined storage capacity. In some configurations, the total combined capacity of the integrated storage 918 and the removable storage 920 is shown to a user instead of separate storage capacities for the integrated storage 918 and the removable storage 920.

The removable storage 920 is configured to be inserted into a removable storage memory slot (not shown) or other mechanism by which the removable storage 920 is inserted and secured to facilitate a connection over which the removable storage 920 can communicate with other components of the computing device, such as the processor 902. The removable storage 920 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 904 can store an operating system. According to various configurations, the operating system includes, but is not limited to WINDOWS MOBILE OS from Microsoft Corporation of Redmond, Washington, WINDOWS PHONE OS from Microsoft Corporation, WINDOWS from Microsoft Corporation, BLACKBERRY OS from Research In Motion Limited of Waterloo, Ontario, Canada, IOS from Apple Inc. of Cupertino, California, and ANDROID OS from Google Inc. of Mountain View, California. Other operating systems are contemplated.

The network connectivity components 906 include a wireless wide area network component (“WWAN component”) 922, a wireless local area network component (“WLAN component”) 924, and a wireless personal area network component (“WPAN component”) 926. The network connectivity components 906 facilitate communications to and from the network 956 or another network, which may be a WWAN, a WLAN, or a WPAN. Although only the network 956 is illustrated, the network connectivity components 906 may facilitate simultaneous communication with multiple networks. For example, the network connectivity components 906 may facilitate simultaneous communications with multiple networks via one or more of a WWAN, a WLAN, or a WPAN.

The network 956 may be or may include a WWAN, such as a mobile telecommunications network utilizing one or more mobile telecommunications technologies to provide voice and/or data services to a computing device utilizing the computing device architecture 900 via the WWAN component 922. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 956 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 956 may be configured to provide voice and/or data communications with any combination of the above technologies. The network 956 may be configured to or adapted to provide voice and/or data communications in accordance with future generation technologies.

In some configurations, the WWAN component 922 is configured to provide dual-multi-mode connectivity to the network 956. For example, the WWAN component 922 may be configured to provide connectivity to the network 956, wherein the network 956 provides service via GSM and UMTS technologies, or via some other combination of technologies. Alternatively, multiple WWAN components 922 may be utilized to perform such functionality, and/or provide additional functionality to support other non-compatible technologies (i.e., incapable of being supported by a single WWAN component). The WWAN component 922 may facilitate similar connectivity to multiple networks (e.g., a UMTS network and an LTE network).

The network 956 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 924 is configured to connect to the network 956 via the WI-FI access points. Such connections may be secured via various encryption technologies including, but not limited, WI-FI Protected Access (“WPA”), WPA2, Wired Equivalent Privacy (“WEP”), and the like.

The network 956 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 926 is configured to facilitate communications with other devices, such as peripherals, computers, or other computing devices via the WPAN.

The sensor components 908 include a magnetometer 928, an ambient light sensor 930, a proximity sensor 932, an accelerometer 934, a gyroscope 936, and a Global Positioning System sensor (“GPS sensor”) 938. It is contemplated that other sensors, such as, but not limited to, temperature sensors or shock detection sensors, also may be incorporated in the computing device architecture 900.

The magnetometer 928 is configured to measure the strength and direction of a magnetic field. In some configurations the magnetometer 928 provides measurements to a compass application program stored within one of the memory components 904 in order to provide a user with accurate directions in a frame of reference including the cardinal directions, north, south, east, and west. Similar measurements may be provided to a navigation application program that includes a compass component. Other uses of measurements obtained by the magnetometer 928 are contemplated.

The ambient light sensor 930 is configured to measure ambient light. In some configurations, the ambient light sensor 930 provides measurements to an application program stored within one of the memory components 904 in order to automatically adjust the brightness of a display (described below) to compensate for low-light and high-light environments. Other uses of measurements obtained by the ambient light sensor 930 are contemplated.

The proximity sensor 932 is configured to detect the presence of an object in proximity to the computing device without direct contact. In some configurations, the proximity sensor 932 detects the presence of a user's body (e.g., the user's face) and provides this information to an application program stored within one of the memory components 904 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 932 are contemplated.

The accelerometer 934 is configured to measure proper acceleration. In some configurations, output from the accelerometer 934 is used by an application program as an input mechanism to control some functionality of the application program. For example, the application program may be a video game in which a character, a portion thereof, or an object is moved or otherwise manipulated in response to input received via the accelerometer 934. In some configurations, output from the accelerometer 934 is provided to an application program for use in switching between landscape and portrait modes, calculating coordinate acceleration, or detecting a fall. Other uses of the accelerometer 934 are contemplated.

The gyroscope 936 is configured to measure and maintain orientation. In some configurations, output from the gyroscope 936 is used by an application program as an input mechanism to control some functionality of the application program. For example, the gyroscope 936 can be used for accurate recognition of movement within a 3D environment of a video game application or some other application. In some configurations, an application program utilizes output from the gyroscope 936 and the accelerometer 934 to enhance control of some functionality of the application program. Other uses of the gyroscope 936 are contemplated.

The GPS sensor 938 is configured to receive signals from GPS satellites for use in calculating a location. The location calculated by the GPS sensor 938 may be used by any application program that requires or benefits from location information. For example, the location calculated by the GPS sensor 938 may be used with a navigation application program to provide directions from the location to a destination or directions from the destination to the location. Moreover, the GPS sensor 938 may be used to provide location information to an external location-based service, such as E911 service. The GPS sensor 938 may obtain location information generated via WI-FI, WIMAX, and/or cellular triangulation techniques utilizing one or more of the network connectivity components 906 to aid the GPS sensor 938 in obtaining a location fix. The GPS sensor 938 may also be used in Assisted GPS (“A-GPS”) systems.

The I/O components 910 include a display 940, a touchscreen 942, a data I/O interface component (“data I/O”) 944, an audio I/O interface component (“audio I/O”) 946, a video I/O interface component (“video I/O”) 948, and a camera 950. In some configurations, the display 940 and the touchscreen 942 are combined. In some configurations two or more of the data I/O component 944, the audio I/O component 946, and the video I/O component 948 are combined. The I/O components 910 may include discrete processors configured to support the various interface described below, or may include processing functionality built-in to the processor 902.

The display 940 is an output device configured to present information in a visual form. In particular, the display 940 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 940 is a liquid crystal display (“LCD”) utilizing any active or passive matrix technology and any backlighting technology (if used). In some configurations, the display 940 is an organic light emitting diode (“OLED”) display. Other display types are contemplated.

The touchscreen 942, also referred to herein as a “touch-enabled screen,” is an input device configured to detect the presence and location of a touch. The touchscreen 942 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 942 is incorporated on top of the display 940 as a transparent layer to enable a user to use one or more touches to interact with objects or other information presented on the display 940. In other configurations, the touchscreen 942 is a touch pad incorporated on a surface of the computing device that does not include the display 940. For example, the computing device may have a touchscreen incorporated on top of the display 940 and a touch pad on a surface opposite the display 940.

In some configurations, the touchscreen 942 is a single-touch touchscreen. In other configurations, the touchscreen 942 is a multi-touch touchscreen. In some configurations, the touchscreen 942 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 942. As such, a developer may create gestures that are specific to a particular application program.

In some configurations, the touchscreen 942 supports a tap gesture in which a user taps the touchscreen 942 once on an item presented on the display 940. The tap gesture may be used for various reasons including, but not limited to, opening or launching whatever the user taps. In some configurations, the touchscreen 942 supports a double tap gesture in which a user taps the touchscreen 942 twice on an item presented on the display 940. The double tap gesture may be used for various reasons including, but not limited to, zooming in or zooming out in stages. In some configurations, the touchscreen 942 supports a tap and hold gesture in which a user taps the touchscreen 942 and maintains contact for at least a pre-defined time. The tap and hold gesture may be used for various reasons including, but not limited to, opening a context-specific menu.

In some configurations, the touchscreen 942 supports a pan gesture in which a user places a finger on the touchscreen 942 and maintains contact with the touchscreen 942 while moving the finger on the touchscreen 942. The pan gesture may be used for various reasons including, but not limited to, moving through screens, images, or menus at a controlled rate. Multiple finger pan gestures are also contemplated. In some configurations, the touchscreen 942 supports a flick gesture in which a user swipes a finger in the direction the user wants the screen to move. The flick gesture may be used for various reasons including, but not limited to, scrolling horizontally or vertically through menus or pages. In some configurations, the touchscreen 942 supports a pinch and stretch gesture in which a user makes a pinching motion with two fingers (e.g., thumb and forefinger) on the touchscreen 942 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 942. As such, the above gestures should be understood as being illustrative and should not be construed as being limiting in any way.

The data I/O interface component 944 is configured to facilitate input of data to the computing device and output of data from the computing device. In some configurations, the data I/O interface component 944 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 946 is configured to provide audio input and/or output capabilities to the computing device. In some configurations, the audio I/O interface component 946 includes a microphone configured to collect audio signals. In some configurations, the audio I/O interface component 946 includes a headphone jack configured to provide connectivity for headphones or other external speakers. In some configurations, the audio I/O interface component 946 includes a speaker for the output of audio signals. In some configurations, the audio I/O interface component 946 includes an optical audio cable out.

The video I/O interface component 948 is configured to provide video input and/or output capabilities to the computing device. In some configurations, the video I/O interface component 948 includes a video connector configured to receive video as input from another device (e.g., a video media player such as a DVD or BLURAY player) or send video as output to another device (e.g., a monitor, a television, or some other external display). In some configurations, the video I/O interface component 948 includes a High-Definition Multimedia Interface (“HDMI”), mini-HDMI, micro-HDMI, DisplayPort, or proprietary connector to input/output video content. In some configurations, the video I/O interface component 948 or portions thereof is combined with the audio I/O interface component 946 or portions thereof.

The camera 950 can be configured to capture still images and/or video. The camera 950 may utilize a charge coupled device (“CCD”) or a complementary metal oxide semiconductor (“CMOS”) image sensor to capture images. In some configurations, the camera 950 includes a flash to aid in taking pictures in low-light environments. Settings for the camera 950 may be implemented as hardware or software buttons. The camera can also include any type of sensor using any type of modality, e.g., a first modality may be under infrared, a second modality may be under a different spectrum, e.g., visible light, laser, etc. The camera may also include a time-of-flight sensor which can operate using any suitable medium, e.g., sonar, radar, etc. the camera can also be in the form of a lidar sensor for capturing images and distances device and will object in a surrounding environment.

Although not illustrated, one or more hardware buttons may also be included in the computing device architecture 900. The hardware buttons may be used for controlling some operational aspect of the computing device. The hardware buttons may be dedicated buttons or multi-use buttons. The hardware buttons may be mechanical or sensor-based.

The illustrated power components 914 include one or more batteries 952, which can be connected to a battery gauge 954. The batteries 952 may be rechargeable or disposable. Rechargeable battery types include, but are not limited to, lithium polymer, lithium ion, nickel cadmium, and nickel metal hydride. Each of the batteries 952 may be made of one or more cells.

The battery gauge 954 can be configured to measure battery parameters such as current, voltage, and temperature. In some configurations, the battery gauge 954 is configured to measure the effect of a battery's discharge rate, temperature, age and other factors to predict remaining life within a certain percentage of error. In some configurations, the battery gauge 954 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 912 may also include a power connector, which may be combined with one or more of the aforementioned I/O components 910. The power components 912 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I claim:

1. A computer-implemented method for providing enhanced security in a system utilizing an activity heatmap with cooldown adjustments, the method for execution on the system comprising:
detecting communication of individual messages directed to individual identifiers of a plurality of identifiers;
determining individual scores for individual identifiers of the plurality of identifiers in response to the communication of the individual messages, wherein an individual score for an individual identifier is based on the activity heatmap defining a number of messages directed to the individual identifier and a number of messages directed to other identifiers associated with the individual number;
adjusting the individual score for the individual identifier based on an age of messages directed to the individual identifier and the other numbers associated with the individual number, wherein the adjustment to the individual score includes reducing the score based on the age of the messages from the start of a cooldown period and a predetermined decay rate, wherein the cooldown period has a start time at which the decay rate starts to reduce individual scores for individual identifiers, wherein the individual scores for individual identifiers are further reduced throughout the cooldown period based on the decay rate;
determining that the individual score for the individual identifier meets one or more criteria with respect to a security threshold; and
in response to determining that the individual score for the individual identifier meets one or more criteria with respect to a security threshold, invoking a security measure for the individual identifier, wherein the security measure includes at least one of generating a notification, requiring accounts associated with the individual identifier to utilize other alternative message systems, or requiring accounts associated with the individual identifier to upgrade permissions.

2. The computer-implemented method of claim 1, wherein the individual score for an individual identifier comprises a plurality of score components, including a first score component and other score components, wherein the first score component is based on the number of messages directed to the individual identifier, wherein the other score components are based on the number of messages directed to the other identifiers and a difference between the other identifiers and the individual identifier.

3. The computer-implemented method of claim 1, wherein the individual identifier is an individual phone number, and wherein other identifiers are other phone numbers, wherein the individual score for an individual phone number comprises a plurality of score components, including a first score component and other score components, wherein the first score component is based on the number of messages directed to the individual phone number, wherein the other score components are based on the number of messages directed to the other phone numbers, wherein the number of messages directed to the other phone numbers influence the other score components if the other phone numbers have a threshold number of common phone number digits with the individual phone number.

4. The computer-implemented method of claim 1, wherein the individual score for an individual identifier comprises a plurality of score components, including a first score component and other score components, wherein the first score component is based on the number of messages directed to the individual identifier, wherein the first score component is further based on an age of individual messages directed to the individual identifier, wherein the other score components are based on the number of messages directed to the other identifiers and a difference between the other identifiers and the individual identifier, wherein the other score components are further based on an age of individual messages directed to the other identifiers.

5. The computer-implemented method of claim 1, wherein the individual identifier is an individual phone number, and wherein other identifiers are other phone numbers, wherein the individual score for an individual phone number comprises a plurality of score components, including a first score component and other score components, wherein the first score component is based on the number of messages directed to the individual phone number, wherein the first score component is further based on an age of individual messages directed to the individual phone number, wherein the other score components are based on the number of messages directed to the other phone numbers, wherein the number of messages directed to the other phone numbers influence the other score components if the other phone numbers have a threshold number of common phone number digits with the individual phone number, wherein the other score components are further based on an age of individual messages directed to the other phone numbers.

6. The computer-implemented method of claim 1, wherein the method further comprises: in response to determining that the individual score for the individual identifier does not meet the one or more criteria with respect to the security threshold, restricting an invocation of the security measure for the individual identifier and maintaining permissions for an account associated with the identifier to continue sending messages or initiating phone calls.

7. The computer-implemented method of claim 1, wherein the individual identifier is an individual phone number, wherein the individual phone number is associated with the other phone numbers when the other phone numbers are within a predetermined range of numbers from the individual phone number, or the individual phone number is associated with the other phone numbers when the individual phone number and the other phone numbers are both within the predetermined range of numbers, or the individual phone number is associated with the other phone numbers when the individual phone number and the other phone numbers have a threshold number of common numbers or common number combinations.

8. The computer-implemented method of claim 1, wherein the adjustment to the individual score includes reducing the score based on the age of the messages from a time the messages are received to a start time of a cooldown period, the predetermined decay rate, and a selected function, wherein the selected function is a linear function or a polynomial function.

9. A computing device for providing enhanced security in a system utilizing an activity heatmap with cooldown adjustments, comprising:
one or more processing units; and
a computer-readable storage medium having encoded thereon computer-executable instructions to cause the one or more processing units to:
detect communication of individual messages directed to individual identifiers of a plurality of identifiers;
determine individual scores for individual identifiers of the plurality of identifiers in response to the communication of the individual messages, wherein an individual score for an individual phone number is based on the activity heatmap defining a number of messages directed to the individual phone number and a number of messages directed to other identifiers associated with the individual number;
adjust the individual score for the individual phone number based on an age of messages directed to the individual phone number and the other numbers associated with the individual number, wherein the adjustment to the individual score includes reducing the score based on the age of the messages from a start of a cooldown period and a predetermined decay rate, wherein the cooldown period has a start time at which the decay rate starts to reduce individual scores for individual identifiers, wherein the individual scores for individual identifiers are further reduced throughout the cooldown period based on the decay rate;
determine that the individual score for the individual phone number meets one or more criteria with respect to a security threshold; and
in response to determining that the individual score for the individual phone number meets one or more criteria with respect to a security threshold, invoke a security measure for the individual phone number, wherein the security measure includes at least one of generating a notification, requiring accounts associated with the individual phone number to utilize other alternative message systems, or requiring accounts associated with the individual phone number to upgrade permissions.

10. The computing device of claim 9, wherein the individual score for an individual phone number comprises a plurality of score components, including a first score component and other score components, wherein the first score component is based on the number of messages directed to the individual phone number, wherein the other score components are based on the number of messages directed to the other identifiers and a difference between the other identifiers and the individual phone number.

11. The computing device of claim 9, wherein the individual score for an individual phone number comprises a plurality of score components, including a first score component and other score components, wherein the first score component is based on the number of messages directed to the individual phone number, wherein the other score components are based on the number of messages directed to the other identifiers, wherein the number of messages directed to the other identifiers influence the other score components if the other identifiers have a threshold number of common phone number digits with the individual phone number.

12. The computing device of claim 9, wherein the individual score for an individual phone number comprises a plurality of score components, including a first score component and other score components, wherein the first score component is based on the number of messages directed to the individual phone number, wherein the first score component is further based on an age of individual messages directed to the individual phone number, wherein the other score components are based on the number of messages directed to the other identifiers and a difference between the other identifiers and the individual phone number, wherein the other score components are further based on an age of individual messages directed to the other identifiers.

13. The computing device of claim 9, wherein the individual score for an individual phone number comprises a plurality of score components, including a first score component and other score components, wherein the first score component is based on the number of messages directed to the individual phone number, wherein the first score component is further based on an age of individual messages directed to the individual phone number, wherein the other score components are based on the number of messages directed to the other identifiers, wherein the number of messages directed to the other identifiers influence the other score components if the other identifiers have a threshold number of common phone number digits with the individual phone number, wherein the other score components are further based on an age of individual messages directed to the other identifiers.

14. The computing device of claim 9, wherein the individual identifier is an individual phone number, wherein the plurality of identifiers is a plurality of phone numbers are limited to at least one of phone numbers within a predetermined range, phone numbers have a predetermined area code, or phone numbers within a predetermined geographic region.

15. The computing device of claim 9, wherein the individual identifier is an individual phone number, and wherein other identifiers are other phone numbers, wherein the plurality of identifiers is a plurality of phone numbers, wherein the individual phone number is associated with the other phone numbers when the other phone numbers are within a predetermined range of numbers from the individual phone number, or the individual phone number is associated with the other phone numbers when the individual phone number and the other phone numbers are both within the predetermined range of numbers, or the individual phone number is associated with the other phone numbers when the individual phone number and the other phone numbers have a threshold number of common numbers or common number combinations.

16. A computer-readable storage medium for providing enhanced security in a system utilizing an activity heatmap with cooldown adjustments, the computer-readable storage medium having encoded thereon computer-executable instructions to cause one or more processing units of the system to:
detect communication of individual messages directed to individual phone numbers of a plurality of phone numbers;
determine individual scores for individual phone numbers of the plurality of phone numbers in response to the communication of the individual messages, wherein an individual score for an individual phone number is based on the activity heatmap defining a number of messages directed to the individual phone number and a number of messages directed to other phone numbers associated with the individual number;
adjust the individual score for the individual phone number based on an age of messages directed to the individual phone number and the other numbers associated with the individual number, wherein the adjustment to the individual score includes reducing the score based on the age of the messages from the start of a cooldown period and a predetermined decay rate, wherein the cooldown period has a start time at which the decay rate starts to reduce individual scores for individual identifiers, wherein the individual scores for individual identifiers are further reduced throughout the cooldown period based on the decay rate;
determine that the individual score for the individual phone number meets one or more criteria with respect to a security threshold; and
in response to determining that the individual score for the individual phone number meets one or more criteria with respect to a security threshold, invoke a security measure for the individual phone number, wherein the security measure includes at least one of generating a notification, requiring accounts associated with the individual phone number to utilize other alternative message systems, or requiring accounts associated with the individual phone number to upgrade permissions.

17. A computer-readable storage medium of claim 16, wherein the individual score for an individual phone number comprises a plurality of score components, including a first score component and other score components, wherein the first score component is based on the number of messages directed to the individual phone number, wherein the other score components are based on the number of messages directed to the other phone numbers and a difference between the other phone numbers and the individual phone number.

18. A computer-readable storage medium of claim 16, wherein the individual score for an individual phone number comprises a plurality of score components, including a first score component and other score components, wherein the first score component is based on the number of messages directed to the individual phone number, wherein the other score components are based on the number of messages directed to the other phone numbers, wherein the number of messages directed to the other phone numbers influence the other score components if the other phone numbers have a threshold number of common phone number digits with the individual phone number.

19. A computer-readable storage medium of claim 16, wherein the individual score for an individual phone number comprises a plurality of score components, including a first score component and other score components, wherein the first score component is based on the number of messages directed to the individual phone number, wherein the first score component is further based on an age of individual messages directed to the individual phone number, wherein the other score components are based on the number of messages directed to the other phone numbers and a difference between the other phone numbers and the individual phone number, wherein the other score components are further based on an age of individual messages directed to the other phone numbers.

20. A computer-readable storage medium of claim 16, wherein the individual score for an individual phone number comprises a plurality of score components, including a first score component and other score components, wherein the first score component is based on the number of messages directed to the individual phone number, wherein the first score component is further based on an age of individual messages directed to the individual phone number, wherein the other score components are based on the number of messages directed to the other phone numbers, wherein the number of messages directed to the other phone numbers influence the other score components if the other phone numbers have a threshold number of common phone number digits with the individual phone number, wherein the other score components are further based on an age of individual messages directed to the other phone numbers.
